(19) United States
(12) Patent Application Publication
(10) Pub. No.: US 2026/0062073 A1
(43) Pub. Date: Mar. 5, 2026

(54) METHODS AND SYSTEMS FOR DETECTING OPERATIONAL PARAMETERS OF TRACK SYSTEMS OF TRACKED VEHICLES

(71) Applicant: SOUCY INTERNATIONAL INC., Drummondville (CA)

(72) Inventors: Etienne LEBLANC, Becancour (CA); Jonathan FRENETTE-MARCOUX, Drummondville (CA); Michael CHARRETTE, Saint-Felix de Kingsey (CA)

(21) Appl. No.: 19/106,426

(22) PCT Filed: Sep. 8, 2023
(86) PCT No.: PCT/IB2023/058934

§ 371 Date: Feb. 25, 2025

Related U.S. Application Data
(60) Provisional application No. 63/404,872, filed on Sep. 8, 2022.
(60) Provisional application No. 63/423,262, filed on Nov. 7, 2022.
(60) Provisional application No. 63/423,253, filed on Nov. 7, 2022.

(51) Int. Cl. B62D 55/12; B62D 55/30; B62D 55/32

(52) U.S. Cl. CPC B62D 55/12; B62D 55/30; B62D 55/32

(57) ABSTRACT

Track systems, methods of controlling a track system and methods of calibrating track systems are disclosed. The track system for a vehicle includes a frame, a first component and a second component connected to the frame, and a sensor device directly connected to the first component and not directly connected to the second component. The sensor device is configured to capture a sensor signal indicative of a first operational parameter of the first component, and the sensor signal is to be used for indirectly determining a second operational parameter of the second component.

### CROSS-REFERENCE TO RELATED APPLICATIONS

The present application claims priority to U.S. Provisional Patent Application No. 63/404,872, filed Sep. 8, 2022 entitled “METHODS, ELECTRONIC SYSTEMS, TRACKS SYSTEMS, AND MONITORING MODULES FOR DETECTING OPERATIONAL PARAMETERS OF TRACK SYSTEMS AND TRIGGERING ACTIONS BASED THEREON”; and to U.S. Provisional Patent Application No. 63/423,253, filed Nov. 7, 2022 entitled “CONNECTED TRACK KIT”; and to U.S. Provisional Patent Application No. 63/423,262, filed Nov. 7, 2022 entitled “CONNECTED TRACK KIT”, all of which are incorporated by reference herein in their entirety.

### TECHNICAL FIELD

The present technology is broadly related to track systems for vehicles, and more particularly to methods, electronic systems, tracks systems, monitoring modules, sensor devices, and vehicles with track systems for detecting operational parameters of track systems.

### BACKGROUND

Several normally wheeled vehicles often have their wheels replaced by track systems which use an endless traction band or track instead of a tire for propulsion or for steering. Vehicles equipped with track systems typically have improved floatation and traction, particularly when operated over soft terrains. Endless tracks have been used on vehicles to increase surface area in contact with the ground. This increased vehicle footprint results in a lower force per unit area on the ground being traversed than a conventional wheeled vehicle of the same weight.

In a typical embodiment of an endless track system, an endless track is driven by a sprocket in which teeth of the sprocket engage links of the track to drive the track and the vehicle forward. Road wheels are attached to the vehicle through independent suspensions and roll over the track in contact with the ground. In such an embodiment, the road wheels typically do not drive the vehicle forward as only the sprocket is used for providing movement. The direct engagement of the sprocket does not allow for track slippage relative to the sprocket and/or due to friction between track and sprocket.

Components (e.g., track links, bushings, and/or pins) of an undercarriage of a machine wear over time. One technique for detecting wear includes obtaining manual measurements of dimensions of such components. The manual measurements may be compared against pre-determined dimensions of the components. In order to obtain the manual measurements, the machine is required to suspend operation and go into maintenance. Because obtaining manual measurements requires the machine to suspend operation, obtaining manual measurements may negatively affect productivity of the machine.

Additionally, such manual measurements can be inaccurate. Inaccurate measurements of component dimensions, in turn, may result in incorrect predictions regarding an amount wear of the components.

WO 2022093503A1 discloses a method including receiving machine vibration data identifying a measure of vibration, of a machine, over a period of time; segmenting the machine vibration data to obtain time domain signals that include a time domain signal related to vibration associated with an undercarriage of the machine; transforming the time domain signal, using a Fast Fourier Transform (FFT), into a spectral domain signal; identifying, from the spectral domain signal, a signature spectrum associated with a motion of components of the undercarriage of the machine; predicting, based on an amplitude of the signature spectrum, an amount of wear of the components; and causing an action to be performed based on the amount of wear of the components.

### SUMMARY

It is an object of the present technology to ameliorate at least some of the inconveniences present in the prior art.

In a first broad aspect of the present technology, there is provided a track system for a vehicle. The track system comprises a frame, an idler wheel assembly rotatably connected to the frame, an other component connected to frame, an endless track extending around the frame, the idler wheel assembly, and the other component. The track system comprises a tensioner operatively connecting to the frame with the idler wheel assembly for moving the idler wheel assembly with respect to the frame for tensioning the endless track, and a sensor device directly connected to the tensioner and not directly connected to the other component. The sensor device being configured to capture a sensor signal indicative of an operational parameter of the tensioner, the sensor signal for indirectly determining an other operational parameter of the other component.

In some embodiments of the track system, the other component is a support wheel assembly rotatably connected to the frame, and the other operational parameter being a frequency peak of the support wheel assembly during operation.

In some embodiments of the track system, the support wheel assembly is a tandem support wheel assembly.

In some embodiments of the track system, the other component is a sprocket wheel assembly rotatably connected to the frame, and the other operational parameter being a frequency peak of the sprocket wheel assembly during operation.

In some embodiments of the track system, the idler wheel assembly is a first idler wheel assembly, and the other component is a second idler wheel assembly rotatably connected to the frame, and the other operational parameter being a frequency peak of the second idler wheel assembly.

In some embodiments of the track system, the other component is the endless track, and the other operational parameter being at least one of a frequency peak of the endless track, a frequency peak of an outer thread of the endless track, a current misalignment of the endless track, a current debris ingestion, a current size of ingested debris, a current heat build-up in the endless track.

In some embodiments of the track system, the sensor device is a pressure gauge directly connected to the tensioner, the operational parameter being a pressure measurement in the tensioner.

In some embodiments of the track system, the sensor device is a positional sensor directly connected to the tensioner, the operational parameter being a stroke position measurement of the tensioner.

In some embodiments of the track system, the sensor device is a first sensor device and the signal is a first signal. The track system further comprises a second sensor device directly connected to the tensioner and not directly connected to the other component. The second sensor device is configured to capture a second sensor signal indicative of a second operational parameter of the tensioner. The second sensor signal is for determining the other operational parameter of the other component. The first sensor signal is different from the second sensor signal.

In a second broad aspect of the present technology, there is provided a track system for a vehicle. The track system comprises a frame, a first component and a second component connected to the frame, and a sensor device directly connected to the first component and not directly connected to the second component. The sensor device is configured to capture a sensor signal indicative of a first operational parameter of the first component, and the sensor signal is for indirectly determining a second operational parameter of the second component.

In some embodiments of the track system, the track system further comprises a wheel assembly pivotably connected to the frame, the first component being a tensioner operatively connected between the frame and the wheel assembly, the second component being an endless track extending around the frame and the wheel assembly, the tensioner for moving the wheel assembly with respect to the frame for tensioning the endless track.

In a third broad aspect of the present technology, there is provided a method of calibrating a track system. The method comprises assembling the track system in an initial configuration, generating a signal by a sensor device of the track system during test operation of the track system in the initial configuration, generating an initial frequency signature of the track system in the initial configuration based on the signal, in response to a comparison of the initial frequency signature to a pre-determined frequency signature of the track system in a calibrated configuration, calibrating the track system by adjusting the initial configuration to an other configuration.

In some embodiments of the method, the calibrating comprises replacing at least one of an idler wheel assembly, a frame, an endless track, and a tensioner of the track system.

In some embodiments of the method, the calibrating comprises adjusting positioning of at least one of an idler wheel assembly, an endless track, and a tensioner of the track system relative to a frame of the track system.

In some embodiments of the method, the signal is a time-domain signal, and the generating the initial frequency signature includes generating a frequency-domain signal based on the time-domain signal.

In some embodiments of the method, the method further comprises generating an other signal by the sensor during test operation of the track system in the other configuration, generating an other frequency signature of the track system in the other configuration based on the other signal, and comparing the other frequency signature to the pre-determined frequency signature.

In some embodiments of the method, the method further comprises installing the track system in the other configuration on a vehicle, generating a third signal by the sensor device during test operation of the vehicle with the track system in the other configuration, generating an installed frequency signature of the track system in the other configuration on the vehicle based on the third signal.

In some embodiments of the method, the method further comprises in response to a comparison of the installed frequency signature to the pre-determined frequency signature, identifying the installed frequency signature as a normal frequency signature of the track system on the vehicle.

In some embodiments of the method, the method further comprises in response to a comparison of the installed frequency signature to the pre-determined frequency signature, calibrating the track system by adjusting the other configuration to a third configuration, generating a fourth signal by the sensor device during test operation of the vehicle with the track system in the third configuration, generating an other installed frequency signature of the track system in the third configuration on the vehicle based on the fourth signal, in response to a comparison of the other installed frequency signature to the pre-determined frequency signature, identifying the other installed frequency signature as the normal frequency signature of the track system on the vehicle.

In a fourth broad aspect of the present technology, there is provided a method of controlling operation of a track system. The method comprises acquiring a signal from a sensor device directly connected to a first component of the track system, the sensor device not directly connected to a second component of the track system. The method comprises generating a current frequency signature for the track system based on the signal, and the current frequency signature is indicative of a current state of the track system. The method comprises determining an operational parameter of the second component based on at least the current frequency signature, and selecting an action to be performed on the track system in response to the operational parameter.

In some embodiments of the method, the determining the operational parameter includes determining the operational parameter based on a comparison of the frequency signature against the pre-stored frequency signature.

In the context of the present specification, unless expressly provided otherwise, the words “first”, “second”, “third”, etc. have been used as adjectives only for the purpose of allowing for distinction between the nouns that they modify from one another, and not for the purpose of describing any particular relationship between those nouns.

It must be noted that, as used in this specification and the appended claims, the singular form “a”, “an” and “the” include plural referents unless the context clearly dictates otherwise.

As used herein, the term “about” in the context of a given value or range refers to a value or range that is within 20%, preferably within 10%, and more preferably within 5% of the given value or range.

As used herein, the term “and/or” is to be taken as specific disclosure of each of the two specified features or components with or without the other. For example, “A and/or B” is to be taken as specific disclosure of each of (i) A, (ii) B and (iii) A and B, just as if each is set out individually herein.

For purposes of the present application, terms related to spatial orientation when referring to a track assembly and components in relation thereto, such as “vertical”, “horizontal”, “forwardly”, “rearwardly”, “left”, “right”, “above” and “below”, are as they would be understood by a driver of a vehicle to which the track assembly is connected, in which the driver is sitting on the vehicle in an upright driving position, with the vehicle steered straight-ahead and being at rest on flat, level ground.

Implementations of the present technology each have at least one of the above-mentioned objects and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects, and advantages of implementations of the present technology will become apparent from the following description, the accompanying drawings, and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 shows a perspective view of a track system for a vehicle in accordance with at least some embodiments of the present technology.

FIG. 2 is a schematic illustration of an other track system for a vehicle in accordance with at least some embodiments of the present technology.

FIG. 3 is a schematic illustration of a computer system in accordance with at least some embodiments of the present technology.

FIG. 4 is a schematic illustration of a networked system including a tracked vehicle in accordance with at least some embodiments of the present technology.

FIG. 5 is a schematic illustration of the other track system of FIG. 2

FIG. 6A is a non-limiting example of a sensor signal generated by a pressure gauge of a tensioner of the track system of FIG. 5 in a first scenario.

FIG. 6B is a non-limiting example of a frequency signal generated by the computer system of FIG. 3 based on the sensor signal of FIG. 6A in the first scenario.

FIG. 7 is a non-limiting example of a frequency signal generated by the computer system of FIG. 3 based on a second sensor signal from the pressure gauge of FIG. 5 in the second scenario.

FIG. 8A is a non-limiting example of a third sensor signal generated by the pressure gauge of FIG. 5 in a third scenario.

FIG. 8B is a non-limiting example of a fourth sensor signal generated by the pressure gauge of FIG. 5 in a fourth scenario.

FIG. 8C is a non-limiting example of a fifth sensor signal generated by the pressure gauge of FIG. 5 in a fifth scenario.

FIG. 8D is a non-limiting example of superimposed frequency signals generated by the computer system of FIG. 3 based on the third fourth and fifth sensor signals of FIGS. 8A-8D.

FIG. 9A is a representation of an endless of the track system of FIG. 5 including a plurality of driving lugs and a plurality of traction lugs, with a zone of the endless track deformed due to a caterpillar effect in accordance with at least some embodiments of the present technology.

FIG. 9B a non-limiting example of superimposed frequency signals generated by the computer system of FIG. 3 based on other sensor signals captured by the pressure gauge of FIG. 5.

FIG. 9C is a zoomed-in portion of the superimposed frequency signals of FIG. 9B showing a first frequency interval specific to an outer thread of the endless track of FIG. 5.

FIG. 9D is an other zoomed-in portion of the superimposed frequency signals of FIG. 9B showing a second frequency interval specific to a first harmonic of the outer thread of the endless track of FIG. 5.

FIG. 10A is a non-limiting example of a thirteenth sensor signal generated by the pressure gauge of FIG. 5 in a thirteenth scenario.

FIG. 10B is a zoomed-in portion of the sensor signal of FIG. 10A.

FIG. 10C is an other zoomed-in portion of the sensor signal of FIG. 10A.

FIG. 11 is a non-limiting example of other superimposed sensor signals generated by the computer system of FIG. 3 based on further sensor signals.

FIG. 12 is a non-limiting example of a seventeenth sensor signal generated by the pressure gauge of FIG. 5 in a seventeenth scenario.

FIG. 13 is a block-scheme representation of a computer-implemented method that is executable by the computer system of FIG. 3 in accordance with at least some embodiments of the present technology.

FIG. 14 is a block-scheme representation of a track system calibration method in accordance with at least some embodiments of the present technology.

### DETAILED DESCRIPTION

The device of the present disclosure solves one or more of the problems set forth above and/or other problems in the art.

The present disclosure is not limited in its application to the details of construction and the arrangement of components set forth in the following description or illustrated in the drawings. The disclosure is capable of other embodiments and of being practiced or of being carried out in various ways. Also, the phraseology and terminology used herein is for the purpose of description and should not be regarded as limiting. The use of “including”, “comprising”, or “having”, “containing”, “involving” and variations thereof herein, is meant to encompass the items listed thereafter as well as, optionally, additional items. In the following description, the same numerical references refer to similar elements.

### First Track System

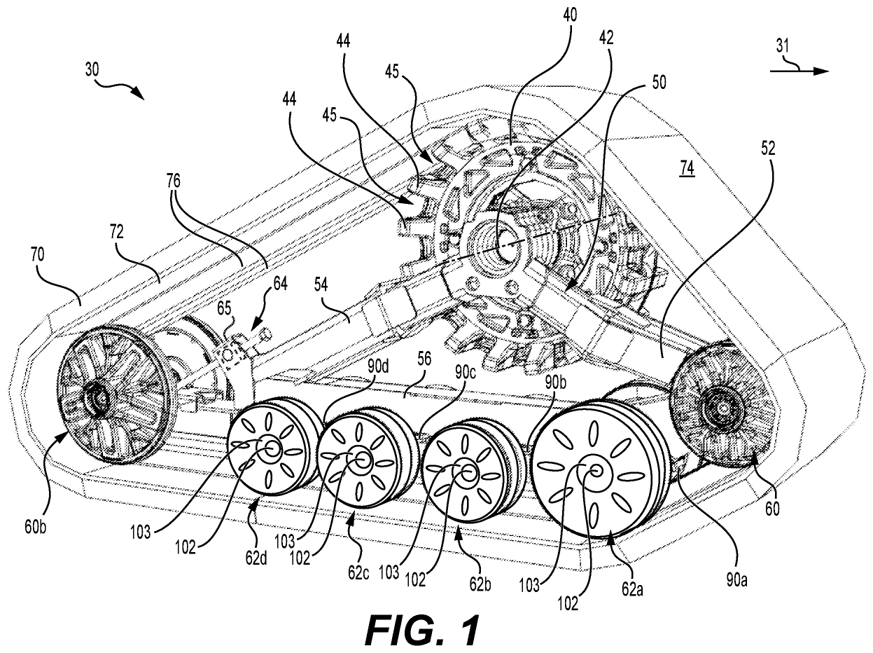

Referring to FIG. 1, the present technology will be described with reference to a track system 30, the forward direction of which is indicated by arrow 31. The track system 30 is operatively connectable to a vehicle (not shown). Specifically, the track system 30 is operatively connectable to a shaft of the vehicle. In some embodiments, the vehicle is an agricultural vehicle such as a harvester, a combine or a tractor. In other embodiments, the vehicle is a construction vehicle such as a bulldozer, a skid-steer loader, an excavator or a compact track loader. In yet other embodiments, the vehicle is a recreational vehicle such as an all-terrain-vehicle, a side-by-side vehicle or utility-terrain vehicle. It is further contemplated that the present technology could be used with industrial and military vehicles as well. It is also contemplated that the present technology could be used with trailers or other unpowered vehicles.

The track system 30 includes a sprocket wheel assembly 40 which can be operatively connected to a driving axle (not shown) of the vehicle. It is contemplated that in some embodiments, the sprocket wheel assembly 40 could be connected to a non-driving axle. The driving axle is configured to drive the sprocket wheel assembly 40 such that the sprocket wheel assembly 40 can rotate about a sprocket axis 42. The sprocket axis 42 is generally perpendicular to the forward direction of travel of the track system 30. The sprocket wheel assembly 40 has a plurality of laterally extending engaging members 44 (i.e., teeth) disposed on a circumference thereof. The sprocket wheel assembly 40 defines a plurality of recesses 45, where each one of the recesses 45 is defined between two engaging members 44. The engaging members 44 and the recesses 45 are adapted, as will be described in greater detail below, to engage with lugs 76 provided on an inner surface 72 of the endless track 70. It is contemplated that in other embodiments, the configuration of the sprocket wheel assembly 40 could differ without departing from the scope of the present technology.

The track system 30 further includes a frame 50. The frame 50 includes a leading frame member 52, a trailing frame member 54 and a lower frame member 56. The leading and trailing frame members 52, 54 are jointly connected, and are configured to be connected around the driving axle of the vehicle. The joint connection is positioned laterally outwardly from the sprocket wheel assembly 40. The leading frame member 52 extends from the driving axle, in the forward and downward directions, and connects to a forward portion of the lower frame member 56. The trailing frame member 54 extends from the driving axle, in the rearward and downward directions, and connects to a rearward portion of the lower frame member 56. The lower frame member 56, which is positioned below the joint connection, extends generally parallel to the forward direction of travel of the track system 30. In the present embodiment, the leading, trailing and lower frame members 52, 54, 56 are integral. It is contemplated that in other embodiments, the leading, trailing and lower frame members 52, 54, 56 could be distinct members connected to one another. It is further contemplated that in some embodiments, the frame 50 could include more or less than three members. In some embodiments, one or more of the leading, trailing and lower frame members 52, 54, 56 could be pivotally connected to one another.

With continued reference to FIG. 1, the track system 30 includes a leading idler wheel assembly 60a, a trailing idler wheel assembly 60b, and four support wheel assemblies 62a, 62b, 62c, 62d. Each of the leading and trailing idler wheel assemblies 60a, 60b includes two laterally spaced wheels. Likewise, each of the support wheel assemblies 62a, 62b, 62c, 62d includes two laterally spaced wheels 100, according to an embodiment of the present technology. It is contemplated that in some embodiments, at least one of the leading and trailing idler wheel assemblies, and the four support wheel assemblies 62a, 62b, 62c, 62d could have a single wheel, or three or more wheels.

The leading idler wheel assembly 60a is rotationally connected to a leading end of the lower frame member 56. It is contemplated that in some embodiments, the leading idler wheel assembly 60 could be rotationally connected to the lower frame member 56 by another component.

The four support wheel assemblies 62a, 62b, 62c, 62d, which are disposed longitudinally rearwardly from the leading idler wheel assembly 60a, are connected to the lower frame member 56 by, respectively, support structures 90a, 90b, 90c, 90d. In some embodiments, the support structures 90a, 90b, 90c, 90d could, respectively, enable the support wheel assemblies 62a, 62b, 62c, 62d to pivot relative to the lower frame member 56. The four support wheels 62a, 62b, 62c, 62d will be described in greater detail below.

The trailing idler wheel assembly 60b is connected to the lower frame member 56 via a tensioner 64. The tensioner 64 is operable to adjust the tension in the endless track 70 by selectively moving the trailing idler wheel assembly 60b toward or away from the frame 50. It is contemplated that in some embodiments, the tensioner 64 could be connected to the leading idler wheel assembly 60a instead of the trailing idler wheel assembly 60b. In some embodiments, the tensioner 64 could be omitted.

A pressure gauge 65 is directly connected to the tensioner 64. The pressure gauge 65 is configured to provide a pressure measurement in the tensioner 64 at different moments in time. It can be said the pressure gauge 65 of the tensioner 64 is a given sensor device directly connected to a given component of the track system 30. The pressure gauge 65 is not directly connected to the endless track 70, for example. Other types of sensor devices are also contemplated. As it will be described in greater details herein further below, a sensor signal may be provided by the pressure gauge to a computer system for processing.

The track system 30 also includes the endless track 70, which extends around components of the track system 50, notably the frame 50, the leading and trailing idler wheel assemblies 60a, 60b, the support wheel assemblies 62a, 62b, 62c, 62d and the support structures 90a, 90b, 90c, 90d. The endless track 70 has the inner surface 72 and an outer surface 74. The inner surface 72 of endless track 70 has the left and right sets of lugs 76, which are adapted to engage within the engaging members 44 of the sprocket wheel assembly 40. It is contemplated that in some embodiments, there could be only one set of lugs 76, or that there could be three or more sets of lugs 76. The outer surface 74 of the endless track 70 has a tread (not shown) defined thereon. It is contemplated that the tread could vary from one embodiment to another. In some embodiments, the tread could depend on the type of vehicle on which the track system 30 is to be used and/or the type of ground surface on which the vehicle is destined to travel. In the present embodiment, the endless track 70 is an endless polymeric track. It is contemplated that in some embodiments, the endless track 70 could be constructed of a wide variety of materials and structures.

The support wheel assemblies 62a, 62b, 62c, 62d will now be described. A diameter of the wheels 100 of the support wheel assembly 62a is larger than a diameter of the wheels 100 of the support wheel assemblies 62b, 62c, 62d. It is contemplated that in some embodiments, the wheels 100 of the four support wheel assemblies 62a, 62b, 62c, 62d could all have the same diameter. Additionally, in some embodiments, one or more of the support wheel assemblies 62a, 62b, 62c, 62d could be a tandem wheel assembly. As the support wheel assemblies 62a, 62b, 62c, 62d are similar, only the support wheel assembly 62a will be described in detail herewith.

As mentioned above, the support wheel assembly 62a includes the two laterally spaced wheels 100, which are generally similar to one another. The support wheel assembly 62a also includes an axle 102 (shown in FIG. 1) interconnecting the two wheels 100, and bearings 103 disposed between the wheels 100 and the axle 102. In some embodiments, the bearings 103 could be omitted. It is understood that the support wheel assembly 62a includes other components such as fasteners. It is contemplated that in some embodiments, the support wheel assembly 62a could include three or more wheels. As the support wheel assembly 62a includes the two laterally spaced wheels 100, the support wheel assembly 62a is sometimes referred to as tandem wheel assembly 62a.

In some implementations of the present technology, the tandem wheel assembly 62a could be configured to have the wheels 100 longitudinally spaced from one another. In such embodiments, axles of the wheels 100, which would also be longitudinally spaced from one another, would be connected to a longitudinally extending member that would, in turn, be connected to the lower frame member 56. In other embodiments, the tandem wheel assembly could be configured to have the wheels 100 both longitudinally and laterally spaced from one another. For example, the tandem wheel assembly could include a leading pair of wheels and a trailing pair of wheels connected to a longitudinally extending member.

### Second Track System

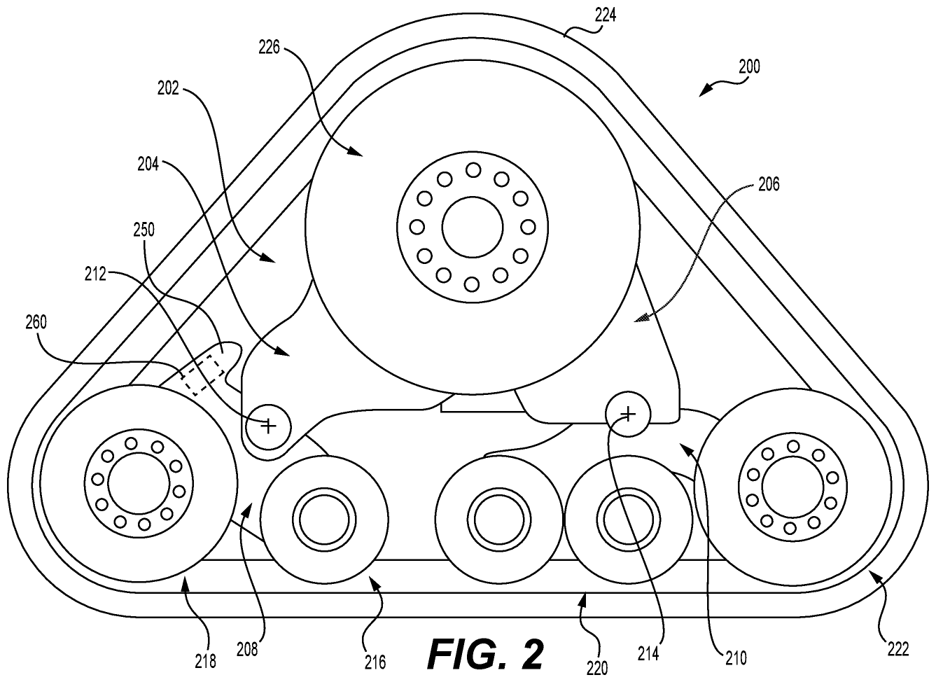

With reference to FIG. 2, there is depicted a partial view of a track system 200. It is contemplated that at least some components of the track system 200 can be implemented in a similar manner to the components of the track system 30 depicted in FIG. 1.

The track system 200 comprise a frame 202. The frame 200 include a first frame portion 204 and a second frame portion 206. The frame 200 also includes a first leading wheel-bearing frame member 208 pivotably connected to the first frame portion 204. The frame 200 also includes a second leading wheel-bearing frame member 210 pivotably connected to the second frame portion 206.

The first wheel-bearing frame member 208 is configured to pivot about a pivot axis 212 and connects a support wheel assembly 216 and an idler wheel assembly 218 to the first frame portion 204. The second wheel-bearing frame member 210 is configured to pivot about a pivot axis 214 and connects a tandem support wheel assembly 220 and an idler wheel assembly 222 to the second frame portion 204.

The support wheel assembly 216 and the tandem support wheel assembly 220 are disposed between the idler wheel assembly 218 and the idler wheel assembly 222. The support wheel assembly 216 and the tandem support wheel assembly 220 assist in distributing the load born by the track system 200 across an endless track 224 of the track system 200. The support wheel assembly 216 is rotatably and pivotably connected to the first wheel-bearing frame member 204. The tandem support wheel assembly 220 is rotatably and pivotably connected to the second wheel-bearing frame member 210.

The track system 200 comprises a sprocket wheel assembly 226 rotatably connected to the frame 202. The endless track 224 extends around the frame 202, the sprocket wheel assembly 226, the idler wheel assembly 218, the idler wheel assembly 222, and the support wheel assemblies 216 and 220. The endless track 224 is drivable by the sprocket wheel 226. The drive sprocket 226 operatively engages the endless track 224 to drive the endless track 224.

The track system 200 comprises a tensioner 250 configured to move the idler wheel assembly 218 with respect to the frame 202 for tensioning the endless track 224. The tensioner 250 is operatively connected between the first frame portion 204 and the first wheel-bearing frame member 208 for controlling relative movement between the first frame portion 204 and the first wheel-bearing frame member 208 and applying tension to the endless track 224.

In some embodiments, the tensioner 250 may have a “cylinder-piston” configuration, where a piston is reciprocally movable within a corresponding cylinder between an extended position and a retracted position. In this configuration, the piston sealingly engages the cylinder for forming a variable volume chamber containing a liquid. In this configuration, the piston is movable between the extended position and the retracted position in a plurality of intermediate positions by changing a volume of the liquid contained in the chamber. As liquid is introduced into the cylinder, it applies pressure to one side of the piston. This pressure, in turn, exerts force and moves the idler wheel assembly 218, thereby creating and/or adjusting tension of the endless track 224.

The track system 200 also comprises a pressure gauge 260 operatively connected to the tensioner 250. Broadly, a pressure gauge is a sensor device used to quantify and/or display pressure of a fluid or gas within a contained system. In this embodiment, the pressure gauge 260 is configured to collect data indicative of pressure of gas within the tensioner 250.

It is contemplated that an other sensor device may be operatively connected to the tensioner 250 in addition to, or instead of, the pressure gauge 260. For example, a position sensor device may be operatively connected to the tensioner 250 for monitoring a current stroke position of the tensioner 250.

It is contemplated that more than one sensor devices may be operatively connected to the tensioner 250 for monitoring one or more types of operational parameters indicative of current operation of the tensioner 250. For example, the tensioner 250 may be operatively connected with the pressure gauge 260 and a position sensor device for monitoring (i) a first operational parameter of the tensioner 250 being a current pressure of gas within the tensioner 250 and (ii) a second operational parameter of the tensioner 250 being a current stroke position of the piston within the tensioner 250.

It is contemplated that a sensor device of a first type collecting a first type of data and a sensor device of a second type collecting a second type of data may be operatively connected to the tensioner 250 simultaneously. For example, the pressure gauge 260 may be operatively connected to the tensioner 250 for collecting a pressure data signal and the position sensor may be operatively connected to the tensioner 250 for collecting position/displacement data signal.

As it will be described in greater details herein further below, data collected by one or more sensor devices operatively connected to the tensioner 250 may be processed and used for triggering one or more actions. Developers of the present technology have realized that processing may be performed on the first type of data signal from a first sensor device and/or on the second type of data signal from a second sensor device. Optionally, the first type of data signal and/or the second type of data signal may be selected for further processing depending on inter alia accuracy of an acquired data signal required for further processing. The second type of data signal may be further processed in addition to the first type of data signal for ensuring reliability of first type of data signal. It is contemplated that providing more than one sensor device may allow redundancy of acquired data signals in case of sensor device failure.

As it will become apparent from the description herein further below, data signals acquired by one or more sensor devices of the track system 200 may be used for monitoring operation of the track system 200 and/or determining one or more operational parameters of one or more components of the track system 200. More particularly, it can be said that one or more sensor devices of the track system 200 are configured to acquire operation data signal about a first component of the track system 200 to which it is directly connected, and the acquired operation data signal are processed for determining one or more operational parameters of a second, different, component of the track system 200 to which it is not directly connected. In other words, the one or more sensor devices can acquire data about operation of the first directly connected component is employed for indirectly determining one or more operational parameters of the indirectly connected second component of the track system 200.

### Computer System

The functions of the various elements shown in the figures, including any functional block labeled as a “processor” or “processing unit”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. In some embodiments of the present technology, the processor may be a general-purpose processor, such as a central processing unit (CPU) or a processor dedicated to a specific purpose, such as a digital signal processor (DSP). Moreover, explicit use of the term a “processor” should not be construed to refer exclusively to hardware capable of executing software, and may implicitly include, without limitation, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown. Moreover, it should be understood that module may include for example, but without being limitative, computer program logic, computer program instructions, software, stack, firmware, hardware circuitry or a combination thereof which provides the required capabilities.

In the context of the present disclosure, the terms “neural network” (NN) and “Machine learning algorithm” (MLA) both refers to a same algorithm generating inferences using a neural network-based architecture. More specifically, the MLA may include an NN, such that execution of the MLA corresponds to an execution of the corresponding NN.

With these fundamentals in place, we will now consider some non-limiting examples to illustrate various implementations of aspects of the present technology.

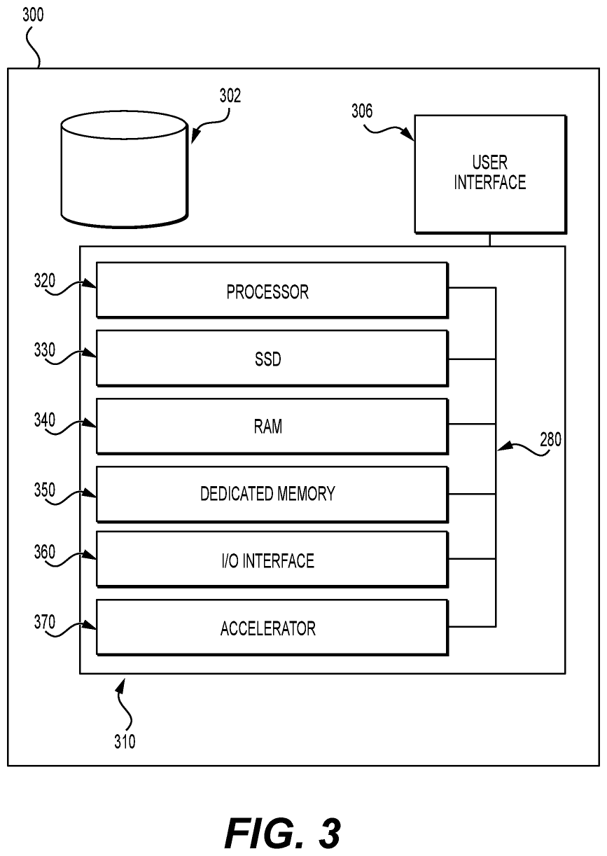

Referring to FIG. 3, there is shown a schematic diagram of a system 300, the system 300 being suitable for implementing non-limiting embodiments of the present technology. It is to be expressly understood that the system 300 as depicted is merely an illustrative implementation of the present technology. Thus, the description thereof that follows is intended to be only a description of illustrative examples of the present technology. This description is not intended to define the scope or set forth the bounds of the present technology. In some cases, what is believed to be helpful examples of modifications to the system 300 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e., where no examples of modifications have been set forth), it should not be interpreted that no modifications are possible and/or that what is described is the sole manner of implementing that element of the present technology. As a person skilled in the art would understand, this is likely not the case. In addition, it is to be understood that the system 300 may provide in certain instances simple implementations of the present technology, and that where such is the case they have been presented in this manner as an aid to understanding. As persons skilled in the art would understand, various implementations of the present technology may be of a greater complexity.

Generally speaking, the system 300 is configured to acquire data captured by one or more sensor devices of the track system 200 to which the system 300 is communicatively connected, process the acquired data, determine one or more operational parameters of one or more components of the track system 200 (and/or a current state of the track system 200), and trigger one or more actions based on the one or more operational parameters (and/or the current state).

The computer system 300 comprises a computing unit 310. In some embodiments, the computing unit 310 may be implemented by any of a conventional personal computer, a controller, and/or an electronic device (e.g., a server, a controller unit, a control device, a monitoring device etc.) and/or any combination thereof appropriate to the relevant task at hand. In some embodiments, the computing unit 310 comprises various hardware components including one or more single or multi-core processors collectively represented by a processor 320, a solid-state drive 330, a RAM 340, a dedicated memory 350 and an input/output interface 360. The computing unit 310 may be a generic computer system.

In some other embodiments, the computing unit 310 may be an “off the shelf” generic computer system. In some embodiments, the computing unit 310 may also be distributed amongst multiple systems. The computing unit 310 may also be specifically dedicated to the implementation of the present technology. As a person in the art of the present technology may appreciate, multiple variations as to how the computing unit 310 is implemented may be envisioned without departing from the scope of the present technology.

Communication between the various components of the computing unit 310 may be enabled by one or more internal and/or external buses 380 (e.g., a PCI bus, universal serial bus, IEEE 1394 “Firewire” bus, SCSI bus, Serial-ATA bus, ARINC bus, etc.), to which the various hardware components are electronically coupled.

The input/output interface 360 may provide networking capabilities such as wired or wireless access. As an example, the input/output interface 360 may comprise a networking interface such as, but not limited to, one or more network ports, one or more network sockets, one or more network interface controllers and the like. Multiple examples of how the networking interface may be implemented will become apparent to the person skilled in the art of the present technology. For example, but without being limitative, the networking interface may implement specific physical layer and data link layer standard such as Ethernet, Fibre Channel, Wi-Fi or Token Ring. The specific physical layer and the data link layer may provide a base for a full network protocol stack, allowing communication among small groups of computers on the same local area network (LAN) and large-scale network communications through routable protocols, such as Internet Protocol (IP).

According to implementations of the present technology, the solid-state drive 330 stores program instructions suitable for being loaded into the RAM 340 and executed by the processor 320. Although illustrated as a solid-state drive 330, any type of memory may be used in place of the solid-state drive 330, such as a hard disk, optical disk, and/or removable storage media.

The processor 320 may be a general-purpose processor, such as a central processing unit (CPU) or a processor dedicated to a specific purpose, such as a digital signal processor (DSP). In some embodiments, the processor 320 may also rely on an accelerator 370 dedicated to certain given tasks. In some embodiments, the processor 320 or the accelerator 370 may be implemented as one or more field programmable gate arrays (FPGAs). Moreover, explicit use of the term “processor”, should not be construed to refer exclusively to hardware capable of executing software, and may implicitly include, without limitation, application specific integrated circuit (ASIC), read-only memory (ROM) for storing software, RAM, and non-volatile storage. Other hardware, conventional and/or custom, may also be included.

Further, the computer system 300 includes a Human-Machine Interface (HMI) 306. The HMI 306 may include a screen or a display capable of rendering an interface including one or more notifications triggered by the computer system 300. In this embodiment, the display of the HMI 306 includes and/or be housed with a touchscreen to permit users to input data via some combination of virtual keyboards, icons, menus, or other Graphical User Interfaces (GUIs). The HMI 306 may thus be referred to as a user interface 306. In some embodiments, the display of the user interface 306 may be implemented using a Liquid Crystal Display (LCD) display or a Light Emitting Diode (LED) display, such as an Organic LED (OLED) display. At least some portions of the user interface 306 may be integrated into a dashboard of the vehicle operable by the user. The device may be, for example and without being limitative, a handheld computer, a personal digital assistant, a cellular phone, a network device, a smartphone, a navigation device, an e-mail device, a game console, or a combination of two or more of these data processing devices or other data processing devices. For example, the user may communicate with the computing unit 310 (i.e., send instructions thereto and receive information therefrom) by using the user interface 306 wirelessly connected to the computing unit 310. The computing unit 310 may be communicate with the user interface 306 via a network (not shown) such as a Local Area Network (LAN) and/or a wireless connexion such as a Wireless Local Area Network (WLAN).

The computer system 300 may comprise a memory 302 communicably connected to the computing unit 310 for storing data received, processed, and/or generated by the computer system 300. The memory 302 may be embedded in the system 300 as in the illustrated embodiment of FIG. 3 or located in an external physical location. The computing unit 310 may be configured to access a content of the memory 302 via a network (not shown) such as a Local Area Network (LAN) and/or a wireless connexion such as a Wireless Local Area Network (WLAN).

As it will become apparent form the description herein further below, the memory 302 may be configured to store data collected by one or more sensor devices of a given track system, such as the data collected by the pressure gauge 206 of the track system 200, for example. In some embodiments of the present technology, it is contemplated that the memory 302 may be configured to store historical data collected by one or more sensor devices of a given track system. For example, the content of the memory 302 may include data that has been captured by one or more sensor devices during previous operation of the given track system. The stored data may be available to the processor 320 even following a shutdown of the computer system 300, without departing from the scope of the present technology.

The system 300 may also include a power system (not depicted) for powering the various components. The power system may include a power management system, one or more power sources (e.g., battery, alternating current (AC)), a recharging system, a power failure detection circuit, a power converter or inverter and any other components associated with the generation, management and distribution of power in mobile or non-mobile devices.

It should be noted that the computing unit 310 may be implemented as a conventional computer server. In an example of an embodiment of the present technology, the computing unit 310 may be implemented as a Dell™ PowerEdge™ Server running the Microsoft™ Windows Server™ operating system. Needless to say, the computing unit 310 may be implemented in any other suitable hardware, software, and/or firmware, or a combination thereof. In the depicted non-limiting embodiments of the present technology in FIG. 3, the computing unit 310 is a single computer device. In alternative non-limiting embodiments of the present technology, the functionality of the computing unit 410 may be distributed and may be implemented via multiple computer devices.

Those skilled in the art will appreciate that processor 320 is generally representative of a processing capability that may be provided by, for example, a Central Processing Unit (CPU). In some embodiments, in place of or in addition to one or more conventional CPUs, one or more specialized processing cores may be provided. For example, one or more Graphic Processing Units (GPUs), Tensor Processing Units (TPUs), accelerated processors (or processing accelerators) and/or any other processing unit suitable for training and executing an MLA may be provided in addition to or in place of one or more CPUs. In this embodiment, the processing unit 320 of the computing unit 310 is a Graphical Processing Unit (GPU) and the dedicated memory 340 is a Video Random access Memory (VRAM) of the processing unit 310. In alternative embodiments, the dedicated memory 340 may be a Random Access Memory (RAM), a Video Random Access Memory (VRAM), a Window Random Access Memory (WRAM), a Multibank Dynamic Random Access Memory (MDRAM), a Double Data Rate (DDR) memory, a Graphics Double Data Rate (GDDR) memory, a High Bandwidth Memory (HBM), a Fast-Cycle Random-Access Memory (FCRAM) or any other suitable type of computer memory.

### Networked System

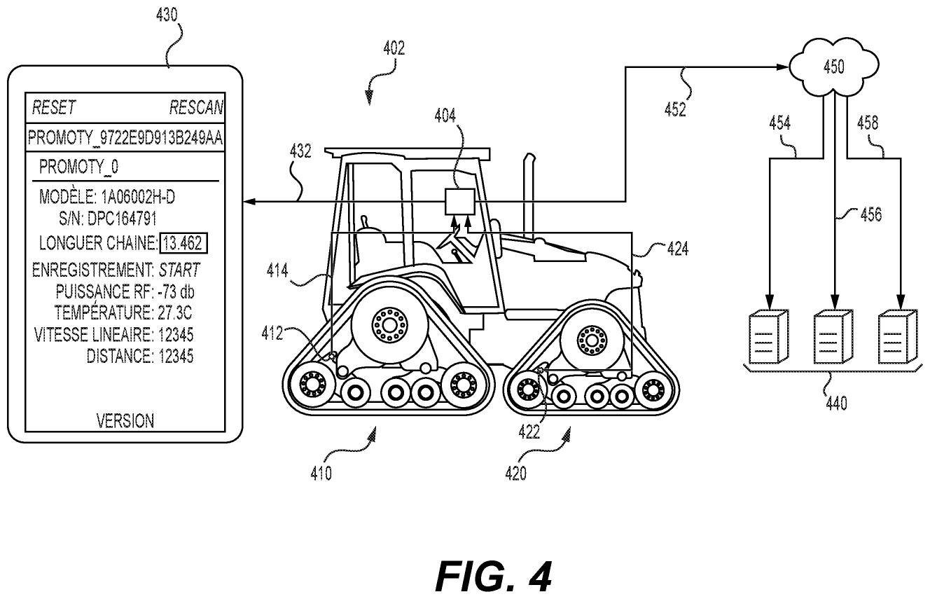

With reference to FIG. 4, there is depicted a networked system 400 as contemplated in at least some embodiments of the present technology.

The networked system 400 comprises a vehicle 402. Broadly, the vehicle 400 is a type of vehicle designed for agricultural applications and is equipped with a front track system 420 and a rear track system 410. The front track system 420 comprises a sensor device 422 and the rear track system 410 comprises a sensor device 412. In some embodiments, the front track system 420 and the rear track system 410 may be embodied similarly to the track system 200 (see FIG. 2).

Other types of vehicles are contemplated. A person skilled in the art will understand that it is also contemplated that some aspects of the present technology in whole or in part could be applied to other types of vehicles such as, for example, agricultural vehicles, industrial vehicles, military vehicles or exploratory vehicles for examples.

In other embodiments, the networked system 400 may comprise an off-road vehicle equipped with front and rear track systems implemented similarly to the track system 30 (see FIG. 1). The off-road vehicle may be a powersport vehicle such as an all-terrain vehicle, a side-by-side vehicle, or a utility-task vehicle, for example.

The vehicle 402 includes an on-board computer system 404. The on-board computer system 404 may be embodied similarly to the computer system 300 without departing from the scope of the present technology. Broadly, the on-board computer system 404 is configured to control operation of the vehicle 402 and to enhance its performance and functionality. The on-board computer system 404 may be configured to enable at least one of the following functions: engine operation management, GPS navigation, diagnostics, operational data. logging, and safety operations. In some embodiments, the on-board computer system 404 may be configured to track speed, acceleration, position, usage time, environmental conditions, and the like.

The on-board computer system 404 is communicatively coupled with the sensor device 422 of the front track system 420 via a communication link 424, and the sensor device 412 of the rear track system 410 via a communication link 414. The on-board computer system 404 is configured to acquire sensor data captured by the sensor device 422 and the sensor device 412.

As it will become apparent from the description herein further below, the on-board computer system 404 may be configured to process (and/or transmit for processing) sensor data captured by sensor devices 422 and 412. In at least some embodiments, the on-board computer system 404 may be configured to condition (and/or transmit for conditioning) data acquired from the sensor devices 422 and 412, analyse (and/or transmit for analysis) conditioned data, and trigger an action in response to data analysis.

In at least some embodiments of the present technology, the on-board computer system 404 may host a detection module or “Hub” that can be used for detecting one or more operational parameters of components of one or more track systems and/or current state of the one or more track systems. For example, the Hub of the on-board computer system 404 may comprise one or more components of the computer system 300 that are configured to detect one or more operational parameters of the components (and/or state of one or more track systems) and trigger actions in response thereto.

In some embodiments, the Hub can be implemented as a dedicated computer system retrofitted onto the vehicle 402 and operatively connected to one or more of the track systems 420 and 410, similarly to the on-board computer system 402. In other embodiments, the Hub can be a dedicated computer system integrated into a given track system itself and communicatively coupled to the on-board computer system 402 and the sensor devices 422 and 412. In further embodiments, the Hub can be remotely connected to the vehicle 402 and/or the track systems 420 and 410 and acquire data and transmit data over the cloud, for example. It is contemplated that the Hub may comprises one or more sensors such as a GPS, an accelerometer, a gyroscope, for example, for monitoring the current speed of the track system and/or of the vehicle. The Hub is configured to execute a variety of computer-implemented algorithms during detection of one or more operational parameters of components of the track system as it will be discussed in greater details herein further below.

The networked system 400 also comprises a user device 430 communicatively coupled to the on-board computer system 402. In some embodiments, the user device 430 may be implemented in a similar manner to how the computer system 300 is implemented. It should be noted that the fact that the user device 102 is associated with an operator of the vehicle 402 does not need to suggest or imply any mode of operation-such as a need to log in, a need to be registered, or the like. Some non-limiting examples of the user device 430 include personal computers (e.g., desktops, laptops), smartphones, tablets and the like. The user device 430 comprises hardware and/or software and/or firmware (or a combination thereof), as is known in the art, to execute a given application.

Generally speaking, the purpose of the application is to enable the operator and/or other user to interact with the vehicle 402. How the given application is implemented is not particularly limited. For example, the operator 101 may use the given application to (i) access information about one or more components of the vehicle 402, the front track system 420, and the rear track system 410, and (ii) in response to user input, trigger actions on one or more components of the vehicle 402, the front track system 420, and the rear track system 410.

To that end, the user device 430 is communicatively coupled to the on-board computer system 430 via a communication link 432. For example, the communication link 432 may be used to transmit data about operation of one or more components of the vehicle 402, the front track system 420, and the rear track system 410. In another example, the communication link 432 may be used to transmit data indicative of user-inputted actions to be performed on one or more components of the vehicle 402, the front track system 420, and the rear track system 410.

The networked system 400 comprises a communication network 110. The purpose of the communication network 110 is to communicatively couple at least some of the components of the networked system 400. In one non-limiting example, the communication network 110 may be implemented as the Internet. In other non-limiting examples, the communication network 110 may be implemented differently, such as any wide-area communication network, local-area communication network, a private communication network and the like. In fact, how the communication network 110 is implemented is not limiting and will depend on inter alia how other components of the system 100 are implemented.

The networked system 400 comprises a plurality of servers 400 communicatively coupled to the on-board computer system via the communication network 110, and more particularly via communication links 452, 454, 456, and 458. The plurality of servers 400 may be implemented as conventional computer servers. In a non-limiting example of an embodiment of the present technology, a given one of the plurality of servers 400 may be implemented as a Dell™ PowerEdge™ Server running the Microsoft™ Windows Server™ operating system. A given one of the plurality of servers 400 may also be implemented in any other suitable hardware and/or software and/or firmware or a combination thereof.

The plurality of servers 400 may be configured to host a database. Generally speaking, a database is configured to acquire data from the on-board computer system, store the data, and/or provide the data to processing resources for further use.

How the communication links 432, 452, 454, 456, 458, 424, and 414 are implemented are not particularly limited. In one implementation, the communication links 414, 424, and 432 may be Bluetooth™ communication links and the communication links 452, 454, 456, and 458 may be 4G wireless communication links.

### General

In at least some embodiments, there are provided solutions for detecting operational parameters of one or more components of a track system and/or a state of the track system. In some embodiments, detection of operational parameters of the one or more components may be performed by monitoring tension and/or variation of tension in an endless track via a sensor device of the track system.

In some embodiments, there is provided a computer system configured to detect operational parameters and/or a state of the track system “indirectly”—that is, the operational parameters are determined without direct monitoring of the one or more components, and rather through processing of data captured by the sensor device. In other words, the computer system may be configured to acquire data from a sensor device connected to a first component of the track system and process the acquired data for determining operational parameters of an other, different, component of the track system to which the sensor device is not directly connected.

For example, the computer system 300 (see FIG. 3) may be configured to acquire pressure data from the pressure gauge 260 (see FIG. 2) directly connected to the tensioner 250 and process the pressure data for detecting operational parameters of at least one of: the endless track 224, the sprocket wheel assembly 226, the support wheel assembly 216, the tandem support wheel assembly 220, the idler wheel assembly 222, the wheel-bearing frame member 210, and the track system 200 itself.

It should be noted that although the pressure gauge 260 is directly connected to the tensioner 250, the pressure gauge 260 is not directly connected to any one of: the endless track 224, the sprocket wheel assembly 226, the support wheel assembly 216, the tandem support wheel assembly 220, the idler wheel assembly 222, the wheel-bearing frame member 210. It should be noted that although the pressure gauge 260 is directly collecting operational data of the tensioner 250, the pressure gauge 260 is not directly collecting operational data of any one of: the endless track 224, the sprocket wheel assembly 226, the support wheel assembly 216, the tandem support wheel assembly 220, the idler wheel assembly 222, the wheel-bearing frame member 210.

Developers of the present technology have realized that indirect detection methods disclosed herein may be more efficient in comparison to prior art solutions because a plurality of operational parameters for respective ones from a plurality of components of the track system 200 may be determined by a single sensor device (such as the pressure gauge 260 of the tensioner 250, for example). Developers of the present technology have realized that indirect detection methods disclosed herein are also “non-intrusive”, meaning that specialized sensors dedicated to the respective ones of the plurality of components may not be required for determining their respective operational parameters. It should be noted that dedicated sensors may affect operation of the at least some components of the track system 200.

In at least some non-limiting embodiments of the present technology, sensor data of a sensor device of the track system 200 may be employed during a conception phase of the track system 200. Developers have devised methods and systems that allow characterization of one or more components of the track system 200 to ameliorate the design of these components and/or of the track system 200 overall. Developers have realized that conventional methods make it difficult to isolate the effect of a design change on the performance of the track system 200.

In at least some non-limiting embodiments of the present technology, sensor data of a sensor device of the track system 200 may be employed during a calibration phase and/or a quality control phase of the track system 200. Developers have devised methods and systems that allow calibration and/or quality control of one or more components of the track system 200 and/or of the track system 200 itself. Developers have realized that conventional methods make it difficult to isolate the effect of an uncalibrated component on the performance of the track system 200.

The computer system 300 is configured to employ sensor data for generating a frequency signature of the track system 200. In some embodiments, the computer system 300 may be configured to generate a frequency signature indicative of a least one of an “initial state” of the track system 200, a “calibrated state” of the track system, a “normal state” of the track system 200, and a “current state” of the track system 200. It is contemplated that a specific configuration (e.g., toe-in or toe-out) of the track system 200 may affect the frequency signature of the track system 200.

Broadly, the “initial state” of the track system 220 corresponds to a state of the standalone track system 200 at the exit of the factory. It is contemplated that an “initial state” of the track system 200 may also corresponds to a state of the track system 200 mounted onto a given vehicle at the exit of the factory. Broadly, the “calibrated state” of the track system 220 corresponds to a state of the standalone track system 200 when calibrated. It is contemplated that an “calibrated state” of the track system 200 may also corresponds to a state of the track system 200 when mounted onto the given vehicle and calibrated. Developers have realized that defects or manufacturing defects could be captured before leaving the factory, because the initial frequency signature would not conform to a calibrated frequency signature of the track system 200.

Broadly, the “normal state” of the track system 220 corresponds to a state of the track system 200 during normal operation of the track system 220. It is contemplated that an “normal state” of the track system 200 may also corresponds to a normalized state of the track system 200 as determined during normal operation over a pre-determined time interval. It is also contemplated that a “normal state” of the track system 200 may also be periodically updated. Therefore, a normal state of the track system 200 may change as the track system 200 is used over time. The normal state may be different from the calibrated state of the track system 200 due to a variety of reasons including at least wear of different components of the track system 200 during normal operation.

Broadly, the “current state” of the track system 220 corresponds to a state of the track system 200 during current operation of the track system 220. It is contemplated that a “current state” of the track system 200 may be different from the calibrated state and/or the normal state due to a variety for reasons. Developers have realized that defects could be detected during operation of the track system 200, because the current frequency signature would not conform to the calibrated frequency signature and/or the normal frequency signature of the track system 200.

It is contemplated that at least some embodiments of the present technology can be employed for track systems that comprise one or more resilient components. For example, developers have realized that methods and systems disclosed herein may be used for determining operational parameters of resilient components (for example, at least partially made from rubber) and/or a state of a track system having at least some resilient components. Developers have realized that behaviour of resilient components may be different from behaviour of non-resilient components (such as metal components, for example). At least some methods and systems disclosed herein may be well-suited for determining operational parameters of components with a resilient behaviour.

In some embodiments of the present technology, a sensor device may be operatively connected to an oscillating component of the track system 200. In the example of FIG. 2, the oscillating component is embodied as the tensioner 250 of the track system 200 and the sensor device is embodied as the pressure gauge 260.

In some embodiments, the computer system 300 may process data captured by the pressure gauge 260 to identify and/or classify frequency signatures of one or more components of the track system 200. The computer system 300 may be configured to compare a current frequency signature of a given component and a calibrated and/or normal frequency signature of that given component and/or detect one or more differences therebetween.

In some embodiments, the computer system 300 may be configured to compare frequency signatures to determine a change in an operational condition of the track system 200. For example, the computer system 300 may be configured to determine based on a frequency signature(s) an operational condition such as, but not limited to: whether the track system 200 is currently operating on a hard ground surface or a soft ground surface, whether the track system 200 has been in contact with an obstacle, whether the track system 200 is currently operating on an incline and/or decline slopes and/or side hill slopes, etc.

In other embodiments, the computer system 300 may be configured to compare frequency signatures to determine a change in a state of one or more components of the track system 200. It is contemplated that the computer system 200 may determine that a change in state of one or more components is attributable to, for example: wear of the endless track 224, wear of the idler wheel 218, wear of the sprocket wheel 226, temperature of at least a portion of the endless track 224, misalignment of wheel(s) of wheel assembles of the track system 200 with the endless track 224, ingestion of debris between the wheel(s) and the endless track 224, and/or wear of any other component of the endless track 200.

As previously alluded to, the sensor device providing sensor data to the computer system 300 for processing may be the pressure gauge 260 directly connected to the tensioner 250 of the track system 200 measuring pressure in the tensioner 250. Also, the sensor device providing sensor data to the computer system 300 for processing may be a position sensor directly connected to the tensioner 250 of the track system 200 measuring a stroke position of the tensioner 250. Additionally, or alternatively, the sensor device providing sensor data to the computer system 300 for processing may be an accelerometer directly connected to a given component of the track system 200 measuring acceleration of the given component of the track system 200. Additionally, or alternatively, the sensor device providing sensor data to the computer system 300 for processing may be a gyroscope directly connected to a given component of the track system 200 measuring angular velocity of the given component of the track system 200. Additionally or alternatively, the sensor device a load cell directly connected to a given component of the track system 200 measuring load exerted on the given component of the track system 200. It is contemplated that a combination of sensor devices may be directly connected to a given component of the track system 200 for measuring operational data about the given component of the track system 200.

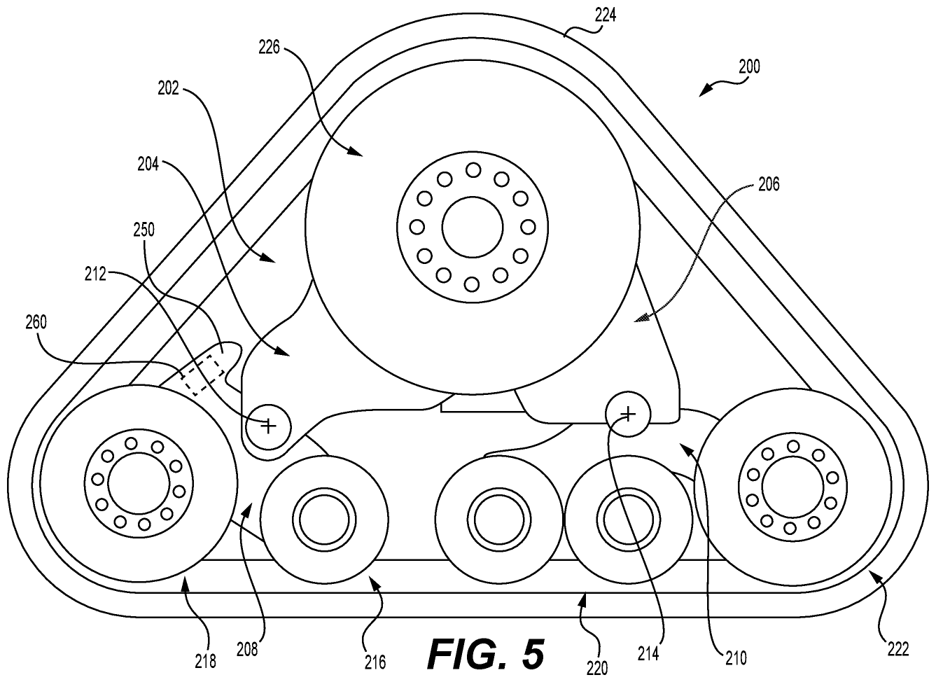

With reference to FIG. 5, there is depicted a schematic illustration of the track system 200. As mentioned above, the pressure gauge 260 of the tensioner 250 may be configured to collect pressure data during operation of the track system 200. As it will now be described in greater details, the computer system 300 may be configured to acquire a plurality of sensor signals during operation of the track system 200 in a variety of scenarios and generate a plurality of current frequency signatures (e.g., current states of the track system 200) based on the respective ones from the plurality of sensor signals. It should be understood that the disclosure below applies similarly to the track system 30 of FIG. 1, without departing from the scope of the present technology.

### First Scenario

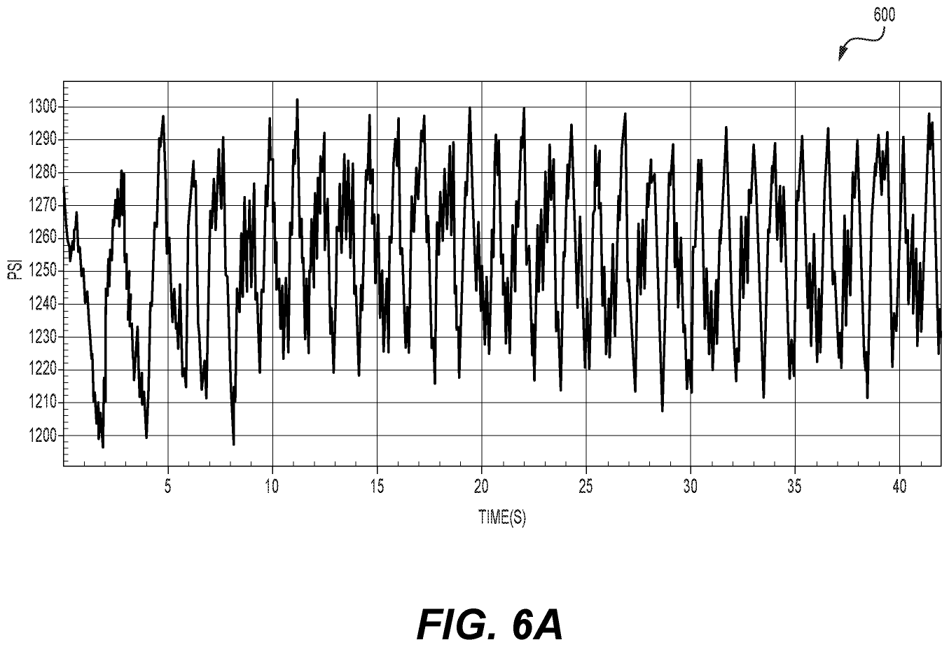

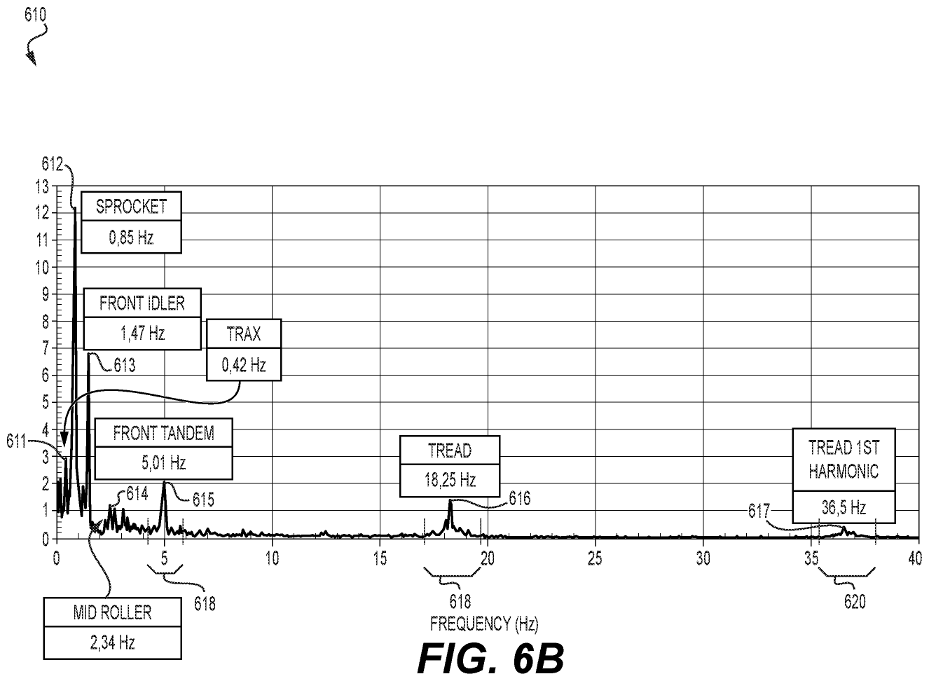

With reference to FIG. 6A, there is depicted a non-limiting example of a sensor signal 600 generated by the pressure gauge 260 of the tensioner 250 of the track system 200 in a first scenario. In the first scenario, the track system 200 is installed on the vehicle 402 and is operated at about 10 km/h on an asphalted surface. As seen, the signal 500 is a time-domain signal representing a pressure measurement (in psi) over time (in seconds).

With reference to FIG. 6B, there is depicted a non-limiting example of a frequency signal 610 generated by the computer system 300 based on the sensor signal 600 in the first scenario. It can be said that the frequency signal 610 is a current frequency signature generated by the computer system 300 in the first scenario. As seen, the frequency signal 610 is a frequency-domain signal representing a root mean square of pressure (psi rms) over different frequencies (in hertz).

It should be noted that the frequency signal 610 comprises a plurality of component-specific peaks comprising peaks 611 to 617. The peak 611 at 0.42 Hz is a peak specific to the endless track 224 during operation of the track system 200 in the first scenario. The peak 612 at 0.85 Hz is a peak specific to the sprocket wheel assembly 226 during operation of the track system 200 in the first scenario. The peak 613 at 1.47 Hz is a peak specific to the front idler wheel assembly 218 during operation of the track system 200 in the first scenario. The peak 614 at 2.34 Hz is a peak specific to the support wheel assembly 216 during operation of the track system 200 in the first scenario. The peak 615 at 5.01 Hz is a peak specific to the front wheel-bearing frame member 208 during operation of the track system 200 in the first scenario. The peak 616 at 18.25 Hz is a peak specific to an outer thread (traction lugs) of the endless track 224 during operation of the track system 200 in the first scenario. The peak 617 at 36.5 Hz is a peak specific to a first harmonic of the outer thread of the endless track 224 during operation of the track system 200 in the first scenario.

In some embodiments, it can be said that the frequency signal 610 comprises a plurality of component-specific frequency intervals for respective components of the track system 200. For example, a first frequency interval 618 including the peak 615 may be a frequency interval specific to the front wheel-bearing frame member 208 during operation of the track system 200 in the first scenario. In the same example, a second frequency interval 619 including the peak 616 may be a frequency interval specific to the outer thread of the endless track 224 during operation of the track system 200 in the first scenario. In the same example, a third frequency interval 6120 including the peak 617 may be a frequency interval specific to the first harmonic of the outer thread of the endless track 224 during operation of the track system 200 in the first scenario.

### Second Scenario

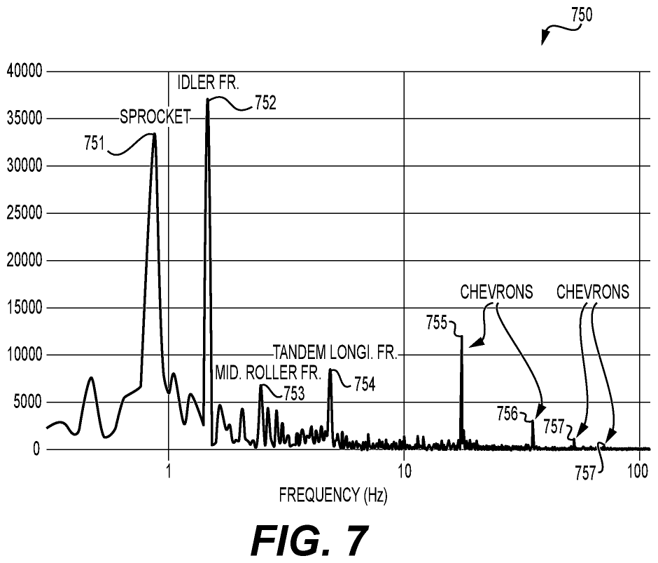

With reference to FIG. 7, there is depicted a non-limiting example of a frequency signal 750 generated by the computer system 300 based on the sensor signal in a second scenario. It can be said that the frequency signal 750 is a current frequency signature generated by the computer system 300 in the second scenario. As seen, the frequency signal 750 is a frequency-domain signal over different frequencies (in hertz).

It should be noted that the frequency signal 750 comprises a plurality of component-specific peaks comprising peaks 751 to 758. The peak 751 is a peak specific to the sprocket assembly 226 during operation of the track system 200 in the second scenario. The peak 752 is a peak specific to the front idler wheel assembly 218 during operation of the track system 200 in the second scenario. The peak 753 is a peak specific to the support wheel assembly 216 during operation of the track system 200 in the second scenario. The peak 754 is a peak specific to the front wheel-bearing frame member 208 during operation of the track system 200 in the second scenario. The peaks 755, 756, 757, and 758 are peaks specific to the outer thread (chevron-line traction lugs) of the endless track 224 during operation of the track system 200 in the second scenario.

### Third, Fourth, and Fifth Scenarios

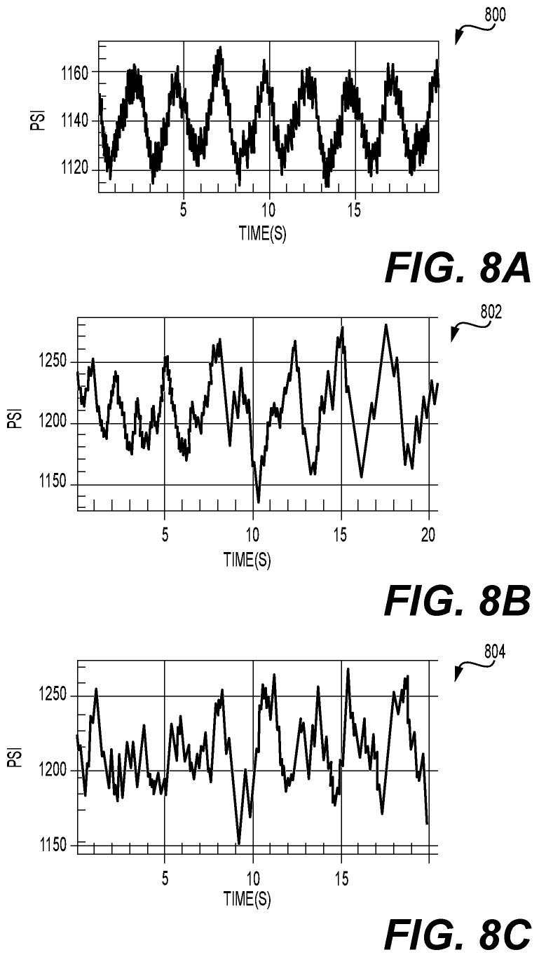

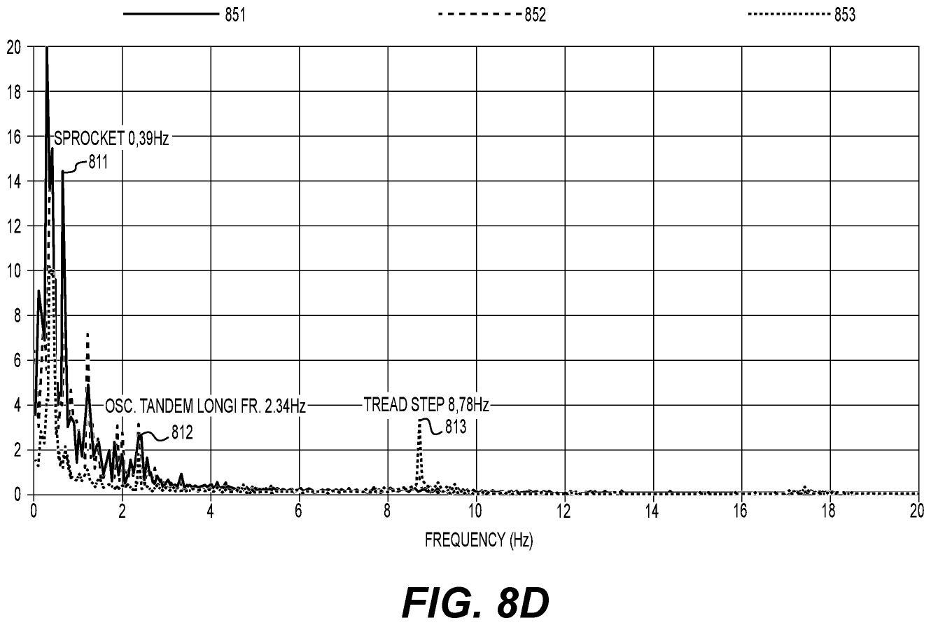

With reference to FIG. 8A, there is depicted non-limiting example of a sensor signal 800 generated by the pressure gauge 260 of the tensioner 250 of the track system 200 in a third scenario. In the third scenario, the track system 200 is installed on the vehicle 402 and is operated at about 5 km/h on a hard ground surface for 20 s. It should be noted that the sensor signal 800 is similar to the sensor signal 700 from the second scenario.

With reference to FIG. 8B, there is depicted non-limiting example of a sensor signal 802 generated by the pressure gauge 260 of the tensioner 250 of the track system 200 in a fourth scenario. In the fourth scenario, the track system 200 is installed on the vehicle 402 and is operated during a first run at about 5 km/h on a soft ground surface (as opposed to the hard ground surface of the third scenario) for 20 s.

With reference to FIG. 8C, there is depicted non-limiting example of a sensor signal 804 generated by the pressure gauge 260 of the tensioner 250 of the track system 200 in a fifth scenario. In the fifth scenario, the track system 200 is installed on the vehicle 402 and is operated during a second run at about 5 km/h on a soft ground surface (as opposed to the hard ground surface of the third scenario) for 20 s.

With reference to FIG. 8D, there is depicted non-limiting example of superimposed frequency signals 851, 852, and 853 generated by the computer system 300 based on the sensor signals 800, 802, and 804, respectively, in the third, fourth and fifth scenarios, respectively. It can be said that the frequency signals 851, 852, and 852 are a respective current frequency signatures generated by the computer system 300 in the third, fourth and fifth scenarios, respectively. As seen, the frequency signals 851, 852, and 852 are frequency-domain signals over different frequencies (in hertz).

It should be noted that each of the frequency signals 851, 852, and 852 comprises a respective plurality of component-specific peaks. As seen, component-specific peaks are similar in each of the frequency signals 851, 852, and 852. A peak 811 is a peak at 0.39 Hz in at least one of the frequency signals 851, 852, and 852 and is specific to the sprocket assembly 226 during operation of the track system 200 in at least one of the third, fourth, and fifth scenarios. A peak 812 is a peak at 2.34 Hz in in at least one of the frequency signals 851, 852, and 852 and is specific to the front wheel-bearing frame member 208 during operation of the track system 200 in at least one of the third, fourth, and fifth scenarios. A peak 813 is a peak at 8.78 Hz in at least one of the frequency signals 851, 852, and 852 and is specific to the outer thread of the endless track 224 during operation of the track system 200 in at least one of the third, fourth, and fifth scenarios.

In some embodiments of the present technology, the computer system 300 can monitor, and store data captured for the track system 200 in its current state. This data can be processed to determine current frequency signatures for the track system 200 and which can also be stored for further comparison when determining current operational parameters of the track system 200 and/or component(s) thereof.

In one non-limiting example, when heat build-up occurs in resilient components (due to deformation, for example), properties of resilient components (e.g., made at least partially from rubber) are affected and the pressure in the tensioner 250 changes. As a result, a given current frequency signature of the track system 200 (and the respective components) may also change as heat builds-up in the resilient components. As such, by comparing a given current frequency signature of the track system 200 during operation against a normal frequency signature of the track system in a normal state may allow determining that heat is building up in the endless track 224 and/or other resilient components of the track system 200.

### Sixth to Twelfth Scenarios

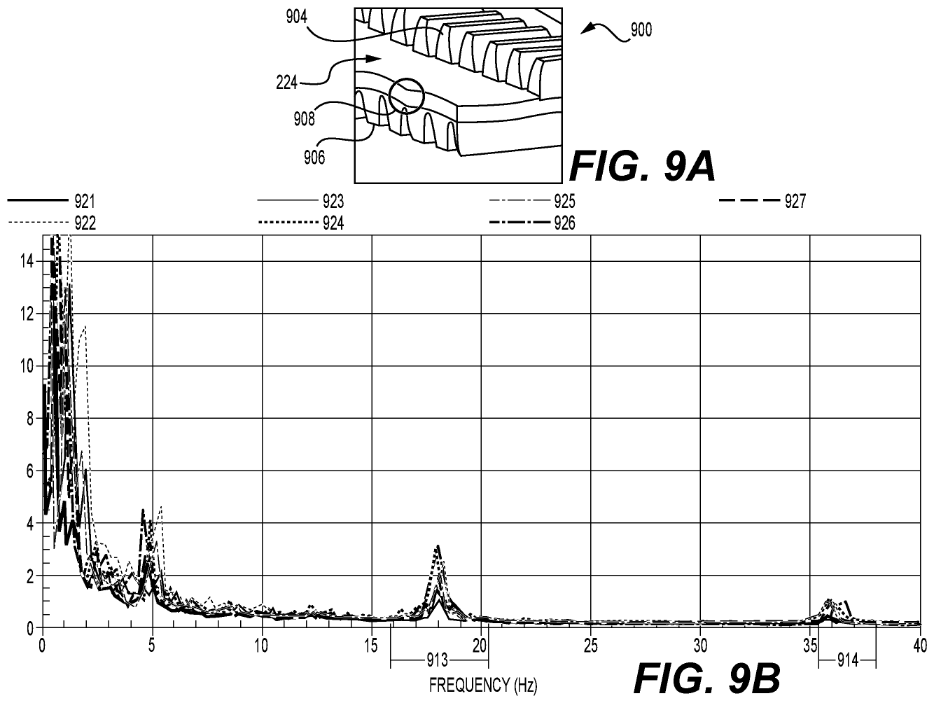

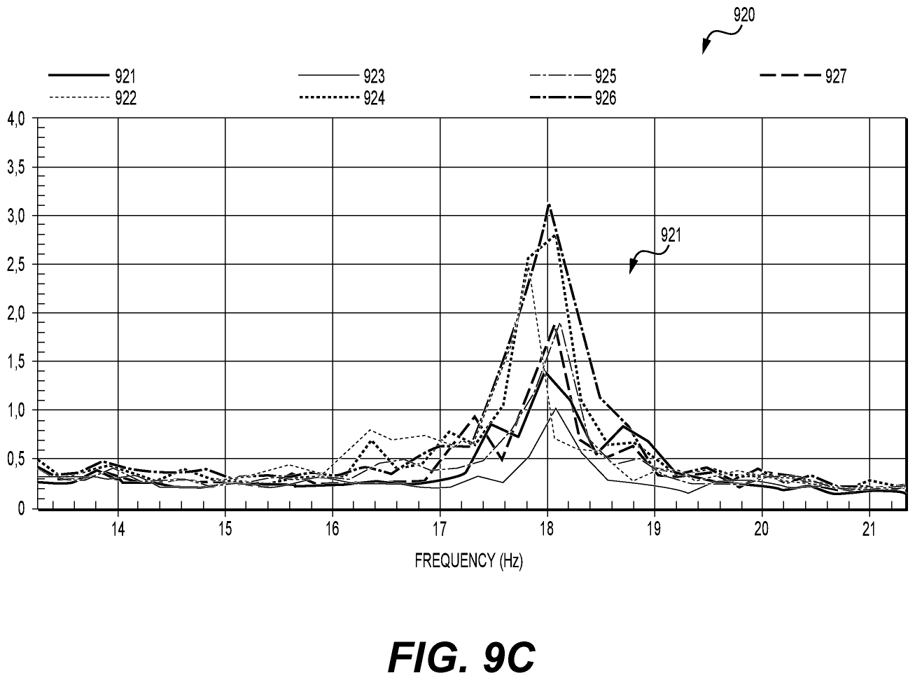

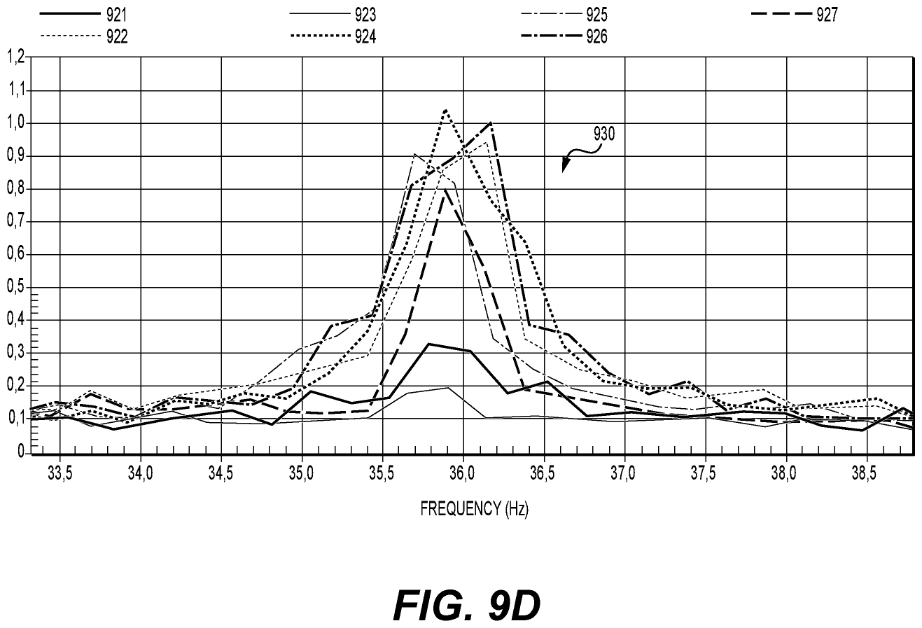

With reference to FIG. 9A, there is depicted a representation 900 of the endless 224 including a plurality of driving lugs 904 and a plurality of traction lugs 906. As seen, a zone 908 of the endless track 224 is deformed due to what is known a “caterpillar effect”. Broadly, during operation, the endless track 224 may deform to conform with a ground surface and which builds up heat in the endless track 224.

With reference to FIG. 9B, there is depicted non-limiting example of superimposed frequency signals 921 to 927 generated by the computer system 300 based on sensor signals (not depicted, respectively, in sixth, seventh, eighth, ninth, tenth, eleventh and twelfth scenarios, respectively. In the sixth, seventh, eighth, ninth, tenth, eleventh and twelfth scenarios, the endless track 224 of the track system 200 has been operated at different temperatures, namely: at 29 C for sixth, seventh scenarios (different runs), 66 C for eighth, ninth scenarios (different runs), 84 C for tenth, eleventh (different runs), and 83 C for twelfth scenario.

It can be said that the frequency signals 921 to 927 are a respective current frequency signatures generated by the computer system 300 in the sixth, seventh, eighth, ninth, tenth, eleventh and twelfth scenarios, respectively. As seen, the frequency signals 921 to 927 are frequency-domain signals representing pressure (in psi rms) over different frequencies (in hertz).

It should be noted that each of the frequency signals 851, 852, and 852 comprises a respective plurality of component-specific frequency intervals. A first frequency interval 913 (which is zoomed in FIG. 9C) is a frequency interval specific for the outer thread of the endless track 224 and a second frequency interval 914 (which is zoomed in FIG. 9D) for the first harmonic of the outer thread of the endless track 224, during operation of the track system 200 in the sixth, seventh, eighth, ninth, tenth, eleventh and twelfth scenarios, respectively.

As best seen in FIG. 9C, peaks 921 of the frequency signals 921 to 927 in the first frequency interval 913 generally increase with the progressively longer operational time intervals of the endless track 224 in the sixth, seventh, eighth, ninth, tenth, eleventh and twelfth scenarios. Similarly, as best seen in FIG. 9D, peaks 930 of the frequency signals 921 to 927 in the second frequency interval 914 generally increase with the progressively longer operational time intervals of the endless track 224 in the sixth, seventh, eighth, ninth, tenth, eleventh and twelfth scenarios.

In some embodiments, the computer system 300 may be configured to generate a given current frequency signature of the track system 200. Based on a comparison against a normal frequency signature of the track system 200, the computer system 300 may determine that heat is building up in the endless track 224. In response, the computer system 300 may trigger an action, such as triggering transmission of a notification to a user interface (e.g., user interface of the on-board computer system 404). Upon receiving the notification, the user may decide to slow down the vehicle 402 to reduce heat build-up, for example.

Other factors affecting the tension of the endless track include, but are not limited to: ground hardness, presence of the obstacle, temperature of the endless track 224 (e.g., average temperature of most affected zones of the rubber), ingestion of debris between wheels and the endless track 224 of the track system 200, misalignment of the endless track 224 relative to the frame 202 of the track system 200, rolling resistance (e.g., wear of bearings and/or pivot assemblies), wear of endless track's 224 components such as of tread, traction teeth, longitudinal reinforcements, wear of other components of the track system 200 such as idler wheels and sprocket wheels.

It is contemplated that data from a given sensor device may be processed for interpreting “artifacts” found therein and indicative of at least some of the above factors affecting the tension of the endless track 224 without departing from the scope of the present technology. Broadly, a given “artifact” in a current frequency signature may correspond to one or more component-specific frequency peaks and/or one or more component-specific frequency intervals.

In some embodiments, artifacts identifiable in a current frequency signature may be directly indicative of a given factor affecting the operational parameter of a sensor device, such as pressure in the tensioner 250 providing the tension of the endless track 224, for example. In these embodiments, the given factor affecting the operational parameter of a sensor device may be determined by the computer system 300 without comparison against a normal frequency signature of the track system 200.

Additionally or alternatively, artifacts identifiable in a current frequency signature may be indirectly indicative of a given factor affecting the operational parameter of a sensor device, such as pressure in the tensioner 250 providing the tension of the endless track 224, for example. In these embodiments, the given factor affecting the operational parameter of a sensor device may be determined by the computer system 300 via a comparison against a normal frequency signature of the track system 200.

Same or different factors may affect other types of signals generated by a sensor device operatively connected to other oscillating components of the track system.

### Thirteenth Scenario

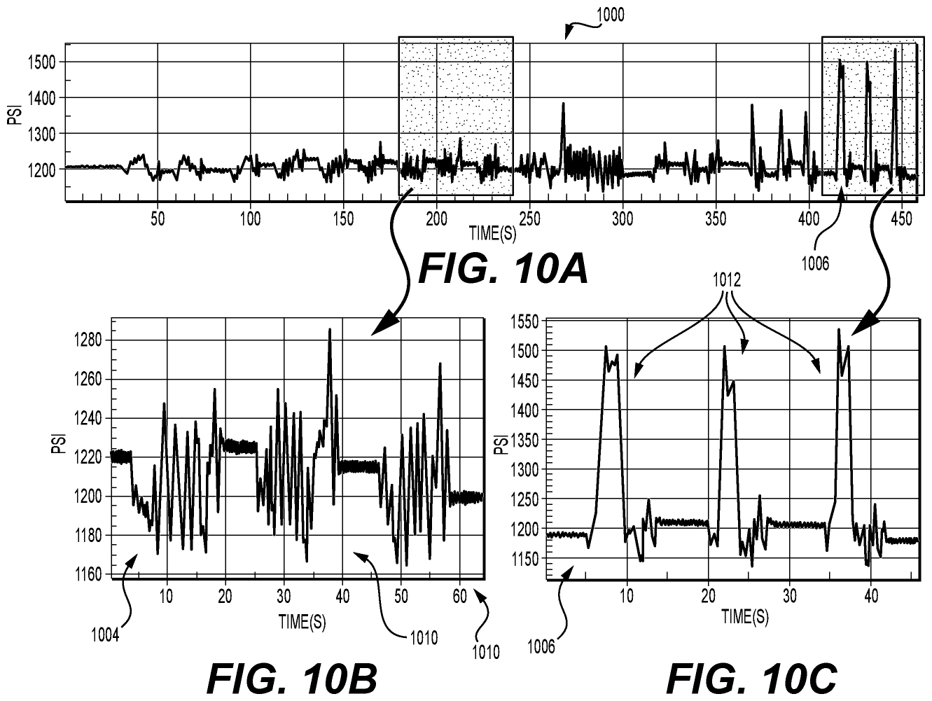

With reference to FIG. 10A, there is depicted non-limiting example of a sensor signal 1000 generated by the pressure gauge 260 of the tensioner 250 of the track system 200 in a thirteenth scenario. In the thirteenth scenario, the track system 200 is installed on the vehicle 402 and is operated at generally constant speed on a ground surface having debris for 450 s.

With reference to FIG. 10B, there is depicted a zoomed-in portion 1004 of the sensor signal 1000. During collection of the portion 1004 of the sensor signal 1000, the track system 200 has been overcoming a debris with a size of 1.5 inches in diameter. With reference to FIG. 10C, there is depicted a zoomed-in portion 1006 of the sensor signal 1000. During collection of the portion 1006 of the sensor signal 1000, the track system 200 has ingested a debris with a size of 1.5 inches in diameter. As seen, a pattern 1010 in the portion 1004 is different from a pattern 1012 in the portion 1006. It is contemplated that the computer system 300 may be configured to discriminate between a debris overcoming event and a debris ingestion event during operation of the track system 200 based on a pattern found in a given portion of a given sensor signal.

### Fourteenth, Fifteenth, and Sixteenth Scenarios

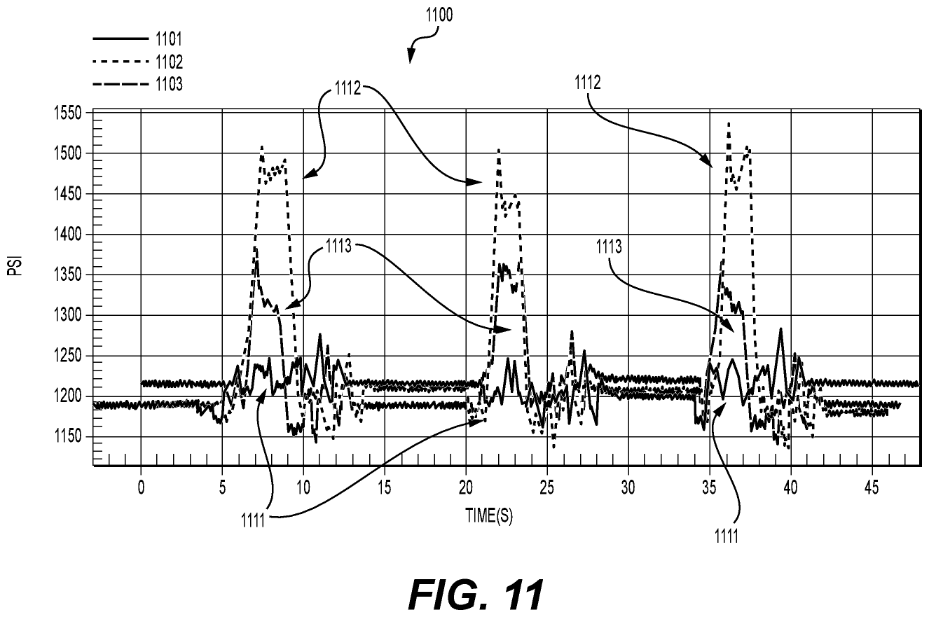

With reference to FIG. 11, there is depicted non-limiting example of superimposed sensor signals 1101, 1102, and 1103 generated by the computer system 300 based on sensor signals (not depicted) respectively, in a fourteenth, fifteenth, and sixteenth scenarios, respectively. In the fourteenth scenario associated with the sensor signal 1101, the endless track 224 ingested a debris with a size of 0.5 inches in diameter. In the fifteenth scenario associated with the sensor signal 1102, the endless track 224 ingested a debris with a size of 1.5 inches in diameter. In the sixteenth scenario associated with the sensor signal 1103, the endless track 224 ingested a debris with a size of 1 inch in diameter. As seen, a pattern 1113 in the sensor signal 1102 is different from a pattern 1113 in the sensor signal 1103 and is different from a pattern 1111 in the sensor signal 1101. It is contemplated that the computer system 300 may be configured to discriminate between size of debris being ingested during operation of the track system 200 based on a pattern found in a given portion of a given sensor signal (e.g., at least based on an amplitude of the pattern). It is contemplated that the size of the debris can be determined based on a size of a pressure peak and/or relative difference in pressure.

### Seventeenth Scenario

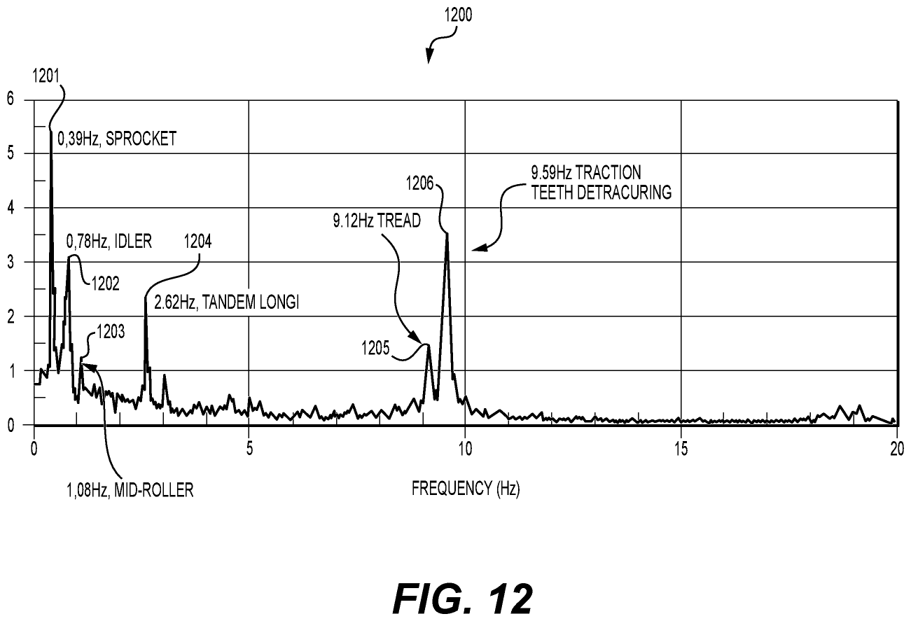

With reference to FIG. 12, there is depicted a non-limiting example of a frequency signal 1200 generated by the computer system 300 based on a sensor signal (not depicted) of the pressure gauge 260 of the tensioner 250 of the track system 200 in a seventeenth scenario. During a seventeenth scenario, the track system 200 has been installed on the vehicle 402 operating at about 5 km/h and where the endless track 224 has been misaligned/detracted.

It should be noted that the frequency signal 1200 comprises a plurality of component-specific peaks comprising peaks 1201 to 1206. The peak 1201 is a peak of 0.39 Hz specific to the sprocket wheel assembly 226 during operation of the track system 200 in the seventeenth scenario. The peak 1202 is a peak of 0.78 Hz specific to the front idler wheel assembly 218 during operation of the track system 200 in the seventeenth scenario. The peak 1203 is a peak of 1.08 Hz specific to the support wheel assembly 216 during operation of the track system 200 in the seventeenth scenario. The peak 1204 is a peak of 1204 specific to the front wheel-bearing frame member 208 during operation of the track system 200 in the seventeenth scenario. The peak 1205 is a peak of 9.12 Hz specific to the outer thread of the endless track 224 during operation of the track system 200 in the seventeenth scenario. The peak 1206 is a peak of 9.59 Hz specific to traction teeth of the endless track 224 being misaligned/detracting (from the sprocket wheel teeth) during operation of the track system 200 in the seventeenth scenario.

In some embodiments, the computer system 300 may trigger one or more actions based on one or more operational parameters determined by the computer system 300 for one or more components of the track system 200 and/or based on a current state of the track system 200. In some embodiments of the present technology, the computer system 300 may trigger at least one of a “passive” action, and “active” action in response to determining one or more operational parameters of components of the track system 200.

For example, passive actions include but are not limited to: notifications for a user of the track system 200, maintenance predictions, and the like. In another example, active actions include but are not limited to: tension adjustment of the endless track 224 using the tensioner 250, alignment adjustment of the endless track 224, overriding user commands in extreme conditions to avoid damaging the track system 200, and the like.

Other operational parameters of components of the track system 200 and/or current states of the track system 200 can be detected/determined by the computer system 300. For example, the computer system 300 may determine occurrence of “ratcheting” in the track system 200. Broadly, ratcheting corresponds to teeth skipping when the sprocket wheel assembly 226 drives the endless track 224. In another example, the computer system 300 may determine occurrence of a “bog down” of the track system 200. Broadly, the track system 200 bogs down when the track system 200 gets stuck in a hole or in a soft ground surface. In a further example, the computer system 300 may determine presence of “field damage”. Broadly, field damage may be indicative of high soil compactness or other notable characteristics of the soil. In yet another example, the computer system 300 may determine occurrence of “mud build-up” in the track system 200. Broadly, when the track system 200 suffers from mud build-up, mud accumulates around and near the wheels of the track system 200 which increases the tension of the endless track 224. In an additional example, the computer system 300 may determine presence of “detracking” signs in the processed signal. Broadly, detracting occurs when one or more components of the track system 200 are misaligned and the endless track 224 disconnects form the track system 200.

### Computer-Implemented Algorithm

In some embodiments of the present technology, there is provided a method executable by the computer system 300 for determining one or more operational parameters of one or more components of a track system. For example, the computer system 300 may receive as input data captured by one or more sensors of the track system. In another example, the computer system 300 may receive data from the vehicle itself (e.g., ECU of the vehicle) and/or from sensors measuring environmental parameters. Sensors measuring environmental parameters may be operated remotely, such as by a drone, a meteoritical device, a smartphone, and the like. It is contemplated that one or more remote sensor devices may be provide data to the computer system 300 over a communication network (e.g., a cloud network, and/or internet).

The method executed by the computer system 300 may allow processing a combination of data signals for determining operational parameters of the one or more components of a track system and/or its current state (represented by its current frequency signature). Processing of data may include processing of temporal data signals and/or frequency data signals. To that end, the computer system 300 may perform spectral analysis of temporal data signals.

The computer system 300 may be configured to determine one or more operational parameters of one or more components of a track system and/or a current frequency signature of the track system.

The computer system 300 may be configured to trigger one or more actions in response to the one or more operational parameters of one or more components of a track system and/or artifacts identified based on at least a current frequency signature of the track system.

In some embodiments of the present technology, one or more functionalities of the computer system 300 can be implemented using Machine Learning Algorithms (MLAs). Non limitative examples of MLAs that can be executed by the computer system 300 may include non-linear algorithm, linear regression, logistic regression, decision tree, support vector machine, naïve bayes, K-nearest neighbors, K-means, random forest, dimensionality reduction, neural network, gradient boosting, adaboost, lasso, elastic net, ridge, bayesian ridge, Automatic Relevance Determination (ARD) regression, Stochastic Gradient Descent (SGD) regressor, passive aggressive regressor, k-neighbors regressor and/or Support Vector Regression (SVR). Other MLAs may also be envisioned without departing from the scope of the present technology.

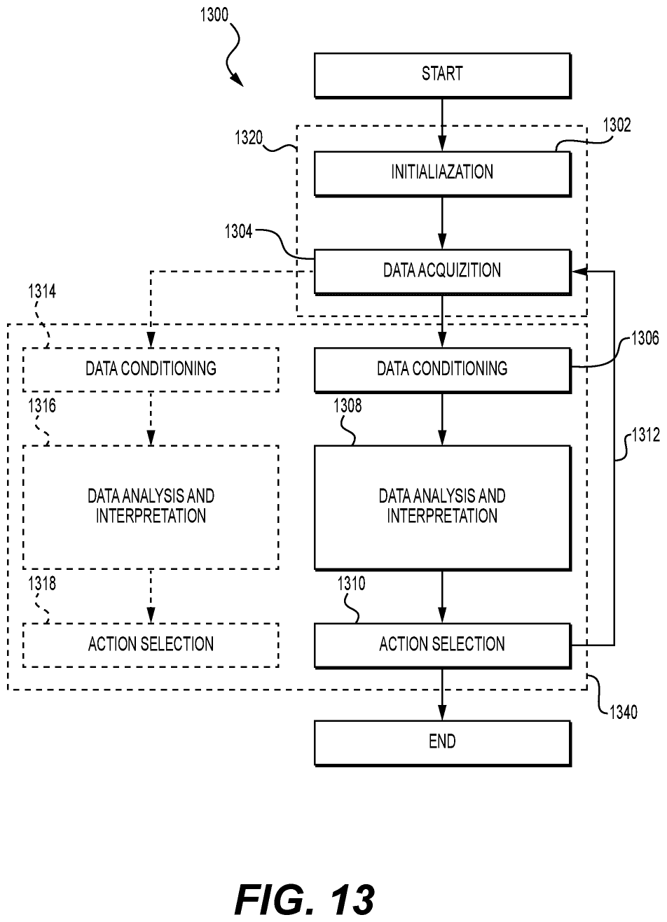

With reference to FIG. 13, there is depicted a block-scheme representation of a computer-implemented method 1300 that is executable by the computer system 300 in at least some embodiments of the present technology. At least some steps may be optional and/or omitted without departing from the scope of the present technology.

### Step 1302: System Initialization

The method 1300 starts with the computer system 300 performing an initialization step 1302. During initialization, the computer system 300 may be provided with electrical power. During initialization the computer system 300 may perform calibration of one or more components of the computer system 300 and/or of the of the track system 200. During initialization, the computer system 300 can trigger a notification via the user interface indicating that the Hub is ready for operation.

### Step 1304: Data Acquisition

The method 1300 continues with the computer system 300 performing a data acquisition step 1304. Data acquisition may be performed continuously and/or periodically by the computer system 300. During acquisition, the computer system 300 may receive data from one or more sensor devices including, but not limited to: a sensor device operatively connected to an oscillating component of the track system 200, a sensor device of the vehicle 402, a sensor device remotely connected to the computer system 300, and/or a sensor device of the Hub.

During data acquisition, the computer system 300 may determine when a minimal amount of data has been acquired in order to proceed to a next step 1306 and/or 1314. How the minimal amount of data is determined is not particularly limited.

In some embodiments, the computer system 300 may acquire a data signal in the temporal domain. It can be said that the computer system 300 may receive a time-domain data signal from a given sensor device. For example, the computer system 300 may acquire from the pressure gauge 260 a time-domain data signal indicative pressure measurements at respective moments in time during operation of the tensioner 250. In another example, the computer system 300 may acquire from a position sensor a time-domain data signal indicative stroke position measurements at respective moments in time during operation of the tensioner 250.

In some embodiments, the computer system 300 may be configured to execute a sliding window algorithm for selecting “chunks” of data signals captured by a given sensor device for further processing. In one implementation, the sliding window algorithm may have a size of 30 seconds for selecting respective chunks of data signals for further processing. In these embodiments, consecutive chunks of data signals may at least partially overlap in the time domain.

As it will be described below, in some embodiments, the computer system 300 may be configured to perform a spectral analysis of a given chunk of data signal during further processing. In these embodiments, the size of the sliding window may depend on inter alia a specific spectral analysis technique being used during further processing.

In some embodiments, the computer system 300 may monitor a current speed of the vehicle 402 and/or of the track system 200. It is contemplated that the computer system 300 may use data captured by a sensor device of the Hub for monitoring the current speed of the vehicle 402 (such as a GPS of the Hub, for example). In these embodiments, the computer system 300 may select chunks of sensor data signals for further processing during which the current speed of the vehicle 402 and/or of the track system 200 has been constant and/or substantially constant.

It should be noted that the steps 1302 and 1304 are included in a first group of steps 1320. In some embodiments, it is contemplated that the first group of steps 1320 may be executed by the on-board computer system 404 of the vehicle 402 without departing from the scope of the present technology.

### Step 1306: Data Conditioning

The method 1300 continues with the computer system 300 executing a data conditioning step 1306. During data conditioning, the computer system 300 may be configured to “pre-process” a given chunk of a sensor data signal. Broadly speaking, the raw chunk of a sensor data signal may be conditioned (thereby generating a conditioned chunk of sensor data signal) for processing. The computer system may be configured to perform one or more known data conditioning techniques during the step 1306, such as for example, filtering techniques, normalization techniques, smoothing techniques, and the like.

In some embodiments, chunk of a time-domain sensor data signal may be conditioned for further processing. In other embodiments, a conditioned chunk of a time-domain sensor data signal may be further conditioned for further processing. In further embodiments, the computer system 300 may be configured to generate a frequency representation of a given chunk of a time-domain sensor data signal. To that end, the computer system 300 may be configured to employ a Fast Fourier Transform (FFT) algorithm. Broadly, A FFT is an algorithm that computes the discrete Fourier transform (DFT) of a sequence, or its inverse (IDFT). Fourier analysis converts a signal from its original domain (often time or space) to a representation in the frequency domain and vice versa. The DFT is obtained by decomposing a sequence of values into components of different frequencies. Other time-to-frequency transformation techniques are also contemplated without departing from the scope of the present technology.

In some embodiments, the computer system 300 may be configured to condition and process chunks of time-domain data signals and/or chunks of frequency-domain data signals in parallel. For example, the computer system 300 may be configured to perform a parallel data conditioning step 1314 in parallel to the data conditioning step 1304. In other embodiments, the computer system 300 may be configured to condition and process the chunks of time-domain data signals and/or chunks of frequency-domain data signals sequentially.

During data conditioning, one or more smoothing techniques, normalization techniques, averaging techniques, data centering techniques, noise reduction techniques may be used. In one embodiment, the computer system 300 may be configured to execute a Savitsky-Golay filter during the data conditioning step.

In further embodiments, the computer system 300 may be configured to execute one or more tendency identification techniques. Broadly. tendency identification techniques in data signals involve methods for recognizing patterns, trends, or tendencies within a dataset. These techniques are used in data analysis, statistics, and machine learning to extract valuable insights from data. For example, descriptive statistics, such as mean, median, and mode, provide measures of central tendency that summarize the typical or central values within a dataset. They offer a quick way to understand the average or most common values in the data. In a second example, histograms may be used to represent distribution of data. They help identify the frequency and spread of values within a dataset, revealing tendencies like skewness and the presence of multiple modes. In a third example, box plots can be used for determining quartiles, median, and potential outliers. They are useful for identifying tendencies in the spread and skewness of data. In a fourth example, for time-series data, techniques like moving averages and exponential smoothing can help identify trends and recurrent patterns over time. In a fifth example, regression models can identify relationships and tendencies between variables by fitting a line or curve to the data points. Linear regression, polynomial regression, and other regression techniques can be used to determine trends and make predictions. In a sixth example, cluster analysis may be performed for grouping similar data points together, helping to identify tendencies in data segmentation and categorization. K-means clustering, and hierarchical clustering are common methods. In a seventh example, for signals with time-varying tendencies, techniques like STFT and Wavelet Transform can be used to determine how frequencies change over time.

### Step 1308: Data Analysis Step

The method 1300 continues with the computer system 300 executing a data analysis step 1308. Broadly speaking, during the data analysis step 1308, the computer system 300 may be configured to “interpret” one or more artifacts that are detected in a conditioned chunk of data signal. The computer system 300 can perform data analysis of a conditioned chunk of time-domain data signal and of a conditioned chunk of frequency-domain data signal in parallel and/or in sequence. For example, the computer system 300 may be configured to perform a parallel data analysis step 1316 in parallel to the data analysis step 1306.

During data analysis of the conditioned chunk of time-domain data signal, the computer system 300 may determine a standard deviation of the conditioned chunk of time-domain data signal. For example, the standard deviation may be indicative of ground properties on which the track system 200 is currently operating. During data analysis of the conditioned chunk of time-domain data signal, the computer system 300 may determine whether the amplitude of the conditioned chunk of time-domain data signal increases and/or decreases. For example, this operational parameter may be indicative of whether the track system 200 has overcome debris and/or has ingested debris. Additionally or alternatively, the amplitude of the conditioned chunk of time-domain data signal may be used for determining a size of ingested debris. During data analysis of the conditioned chunk of time-domain data signal, the computer system 300 may determine a current weight of the vehicle 402. During data analysis of the conditioned chunk of time-domain data signal, the computer system 300 may determine that mud is accumulating near the wheels of the track system 200 as mentioned above.

In some embodiments, the computer system 300 may be configured to identify an artifact in the conditioned chunk of frequency-domain data signal. For example, the computer system 300 may be configured to identify one or more component-specific peaks and/or one or more component-specific frequency intervals in a current frequency signature of the track system 200.

In other embodiments, the computer system 300 may be configured to determine an operational parameter of a component of the track system 200 based on an artifact identified in the conditioned chunk of frequency-domain data signal. For example, the computer system 300 may be configured to determine an operational parameter of a component of the track system 200 based on a current frequency signature of the track system 200.

In further embodiments, the computer system 300 may be configured to determine an operational parameter of a component of the track system 200 based on an artifact identified in the conditioned chunk of frequency-domain data signal and by comparing it to a pre-stored chunk of frequency-domain data signal. For example, the computer system 300 may be configured to determine an operational parameter of a component of the track system 200 based on a current frequency signature of the track system 200 and a normal frequency signature of the track system 200 that has been previously stored in a database accessible by the computer system 300. In these embodiments, the computer system 300 may host a library of frequency signatures having been generated for the track system 200 when the track system in a variety of scenarios and/or applications.

In some embodiments, the library of pre-frequency signatures of the track system 200 may be organized based on a speed at which the track system 200 has been operating in that scenario. For example, a set of pre-stored frequency signatures of the track system 200 may be associated with a speed of about 5 km/h, while an other set of pre-stored frequency signatures of the track system 200 may be associated with a speed of about 25 km/h. In some implementations, the library may store a set for about every 5 km/h increase in speed. For example, the library may store respective sets for a speed of 5 km/h, 10 km/h, 15 km/h, and the like. In other implementations, the library may store a set for every 0.1 km/h increase in speed. For example, the library may store respective sets for a speed of 10.1 km/h, 10.2 km/h, 10.3 km/h, and the like.

In further embodiments, it is contemplated that the computer system 300 may be configured to select a given set of pre-stored frequency signatures (e.g., one or more normal frequency signatures indicative of one or more normal states of the track system 200) for comparison depending on inter alia a current speed of the track system 200. In additional embodiments, if the current speed of the vehicle does not match speeds associated with respective sets of pre-stored frequency signatures, the computer system 300 may select a set associated with a closest speed to the current speed of the track system 200. In yet other embodiments, the computer system 300 may be configured to perform additional conditioning of the current frequency signature for reducing errors during the comparison process. In other words, it can be said that conditioning of a current frequency signature may depend on inter alia the closest speed associated with a given set of pre-stored frequency signatures accessible in the library. This may reduce the memory requirement for storing the library.

In other embodiments, the computer system 300 may be configured to identify an artifact in a current frequency signature without requiring a comparison with a pre-stored frequency signature. For example, the computer system 300 may be configured to determine misalignment of the endless track 224 relative to the track system 200 based on the current frequency signature without comparison to a pre-stored frequency signature (e.g., a normal frequency signature indicative of a normal state of the track system 200).

In some embodiments, the computer system 300 may be configured to detect an operational parameter of a given component of the track system based on at least one artifact from the conditioned chunk of time-domain data signal and at least one artifact from the current conditioned chunk of time-domain data signal.

In additional embodiments, the computer system 300 may be configured to detect operational parameters of components of the track system 200 over extended periods of time. For example, the computer system 300 may be configured to monitor variation of temperature of the endless track 224 over extended use of the track system (days, weeks, or months). Wear of at least some components can be determined over an extended period of time using methods disclosed herein.

### Step 1310: Action Selection Step

The method 1300 continues with the computer system 300 executed an action selection step 1310. Broadly, during the action selection step, the computer system 300 may be configured to select which actions ought to be triggered based on the one or more operational parameters of components of the track system 200 and/or a current frequency signature of the track system 200 and/or a normal frequency signature of the track system 200.

During the action selection, the computer system 300 may be configured to trigger passive actions and/or active actions depending on inter alia which combination of operational parameters of components of the track system 200 and/or a current frequency signature of the track system 200 and/or a normal frequency signature of the track system 200.

In some embodiments, the computer system 300 may be configured to select and/or trigger more than one action in parallel. For example, the computer system 300 may be configured to execute a parallel action selection step 1318 in parallel to executing the action selection step 1310.

The steps 1306, 1308, 1310, 1314, 1316, and 1318 are part of a second group of steps 1340. In some embodiments, at least some of the second group of steps 1340 may be executed by the on-board computer system 404 of the vehicle 402 without departing from the scope of the present technology. In other embodiments, at least some of the second group of steps 1340 may be executed by one or more of the plurality of servers 440 communicatively coupled to the on-board computer system 404 without departing from the scope of the present technology.

In some embodiments, the computer system 300 may train and use a Neural Network (NN) or other type of MLA for determining a mapping between (i) potential operational parameters of components and/or potential current states of the track system and (ii) potential passive and/or active actions to be triggered by the computer system 300 in response thereto.

### Calibration Methods

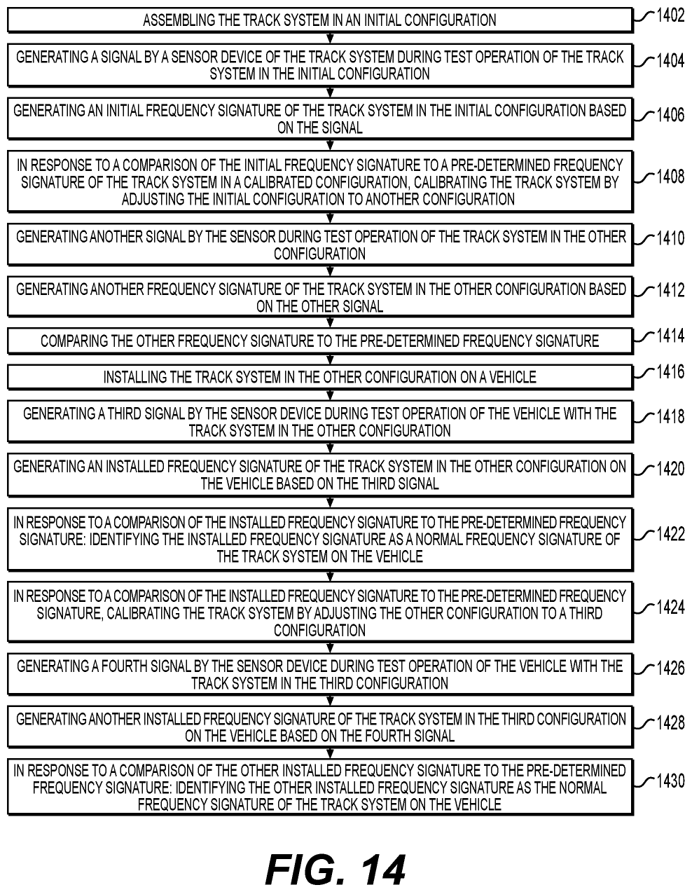

With reference to FIG. 14, there is depicted a block-scheme representation of a calibration method 1400 of the track system 200. It is contemplated that the track system 30 may be calibrated similarly to how the track system 200 is calibrated in accordance with the method 1400. At least some steps of the method 1400 may be optional and/or omitted without departing from the scope of the present technology.

### Step 1402: Assembling the Track System in an Initial Configuration

The method 1400 begins at step 1402, with assembling a track system in an initial configuration. A track system assembly process may be performed by a track system manufacturer. During assembly, components of the track system are installed on a frame of the track system and may include roller, idler, and sprocket assemblies.

In some embodiments, during the step 1402, the track system 200 may be assembled in an initial configuration. The track system 200 comprises the pressure gauge 260 directly connected to the tensioner 250 of the track system 200.

### Step 1404: Generating a Signal by a Sensor Device of the Track System During Test Operation of the Track System in the Initial Configuration

The method 1400 continues to step 1404 with generating a signal by a sensor device of the track system during test operation of the track system in the initial configuration. For example, the track system may be installed on a test bench so it can be operated in test conditions. During such test operation, the sensor device may be used to generate a signal. For example, a time-domain data signal may be generated by the pressure gauge 260 of the tensioner 250 of the track system 200 in the initial configuration.

### Step 1406: Generating an Initial Frequency Signature of the Track System in the Initial Configuration Based on the Signal

The method 1400 continues to step 1406 with generating an initial frequency signature of the track system in the initial configuration based on the signal (from the step 1404). It is contemplated that the signal from the step 1406 may be a time-domain signal, and the generating the initial frequency signature includes generating a frequency-domain signal based on the time-domain signal. One or more spectral analysis techniques may be used for generating the initial frequency signature. It should be noted that the initial frequency signature may be indicative of operational parameters of one or more components of the track system in the initial configuration.

Step 1408: In Response to a Comparison of the Initial Frequency Signature to a Pre-Determined Frequency Signature of the Track System in a Calibrated Configuration, Calibrating the Track System by Adjusting the Initial Configuration to an Other Configuration

The method 1400 continues to step 1408 with in response to a comparison of the initial frequency signature to a pre-determined frequency signature of the track system in a calibrated configuration, calibrating the track system by adjusting the initial configuration to an other configuration.

The pre-determined frequency signature of the track system may have been previously stored by the computer system 300. The pre-determined frequency signature of the track system may have been generated based on the track system in a calibrated/reference configuration. It can be said that the track system in a desired configuration may be operated, a sensor signal may be generated during operation, and a desired frequency signature for the track system may be generated based on the sensor signal. This desired frequency signature may then be stored and used during the calibration method 1400.

The comparison between the initial frequency signature and the pre-determined frequency signature may be performed in a variety of ways. In some embodiments, one or more tendency techniques may be employed by the computer system 300 for performing the comparison. In other embodiments, one or more known comparison techniques may be used for comparing the initial frequency signature and the pre-determined frequency signature. In other embodiments, during the comparison, information about one or more peaks and/or information about one or more frequency intervals from the initial frequency signature may be compared against information about one or more peaks and/or information about one or more frequency intervals from the pre-determined frequency signature.

For example, the comparison may be indicative of a mismatch between information about one or more peaks and/or information about one or more frequency intervals in the initial frequency signature and the corresponding ones in the pre-determined frequency signature. It is contemplated that a mismatch may be indicative of one or more uncalibrated components of the track system (e.g., misalignment of the endless track).

In some embodiments, calibrating the track system may comprise replacing at least one of an idler wheel assembly, a frame, an endless track, and a tensioner of the track system. In other embodiments, calibrating may comprise adjusting positioning of at least one of an idler wheel assembly, an endless track, and a tensioner of the track system relative to a frame of the track system. It can be said that once the track system is calibrated at the step 1408, the track system is no longer in the initial configuration and now is in an other configuration different form the initial configuration.

### Step 1410: Generating an Other Signal by the Sensor During Test Operation of the Track System in the Other Configuration

The method 1400 continues to step 1410 with generating an other signal by the sensor during test operation of the track system in the other configuration. For example, the track system may be installed on a test bench so it can be operated in test conditions. During such test operation, the sensor device may be used to generate the other signal. For example, an other time-domain data signal may be generated by the pressure gauge 260 of the tensioner 250 of the track system 200 in the other configuration.

### Step 1412: Generating an Other Frequency Signature of the Track System in the Other Configuration Based on the Other Signal

The method 1400 continues to step 1412 with generating an other frequency signature of the track system in the other configuration based on the other signal (from the step 1410). It is contemplated that the other signal from the step 1410 may be the other time-domain signal, and the generating the other frequency signature includes generating an other frequency-domain signal based on the other time-domain signal. One or more spectral analysis techniques may be used for generating the other frequency signature. It should be noted that the other frequency signature may be indicative of operational parameters of one or more components of the track system in the other configuration.

### Step 1414: Comparing the Other Frequency Signature to the Pre-Determined Frequency Signature

The method 1400 continues to step 1408 with comparing of the other frequency signature to the pre-determined frequency signature.

The comparison between the other frequency signature and the pre-determined frequency signature may be performed in a variety of ways. In some embodiments, one or more tendency techniques may be employed by the computer system 300 for performing the comparison. In other embodiments, one or more known comparison techniques may be used for comparing the other frequency signature and the pre-determined frequency signature. In other embodiments, during the comparison, information about one or more peaks and/or information about one or more frequency intervals from the other frequency signature may be compared against information about one or more peaks and/or information about one or more frequency intervals from the pre-determined frequency signature.

For example, the comparison may be indicative of a match between information about one or more peaks and/or information about one or more frequency intervals in the other frequency signature and the corresponding ones in the pre-determined frequency signature. It is contemplated that information in at least a frequency portion of the other frequency signature may be at least within a pre-determined threshold from information in at least a corresponding frequency portion the pre-determined frequency signature. It is contemplated that a match between the other frequency signature and the pre-determined frequency signature, and/or the information of the other frequency signature being within a pre-determined threshold from the information of the pre-determined frequency signature, the track system in the other configuration may be considered as being in an acceptable configuration for proceeding to a step 1416 of the method 1400.

### Step 1416: Installing the Track System in the Other Configuration On a Vehicle

The method 1400 continues to step 1416 with installing the track system in the other configuration on a vehicle. For example, the track system 200 in the other configuration may be installed on the vehicle 402. During the installing, the track system 200 may be operatively connected to a motor of the vehicle 402, so that the sprocket assembly 226 can be driven by the motor through an interface during operation of the vehicle 402.

Step 1418: Generating a Third Signal by the Sensor Device During Test Operation of the Vehicle with the Track System in the Other Configuration

The method 1400 continues to step 1418 with generating a third signal by the sensor device during test operation of the vehicle with the track system in the other configuration. For example, the vehicle with the track system may be operated in test conditions. During such vehicle-track test operation, the sensor device may be used to generate the third signal. For example, a third time-domain data signal may be generated by the pressure gauge 260 of the tensioner 250 of the track system 200 installed of the vehicle 402 while the vehicle 402 is operating in the test conditions.

### Step 1420: Generating an Installed Frequency Signature of the Track System in the Other Configuration on the Vehicle Based on The Third Signal

The method 1400 continues to step 1420 with generating an installed frequency signature of the track system in the other configuration on the vehicle based on the third signal. It is contemplated that the third signal from the step 1418 may be the third time-domain signal, and the generating the installed frequency signature includes generating a third frequency-domain signal based on the third time-domain signal. One or more spectral analysis techniques may be used for generating the installed frequency signature. It should be noted that the installed frequency signature may be indicative of operational parameters of one or more components of the track system in the other configuration installed on the vehicle.

### Step 1422: In Response to a Comparison of the Installed Frequency Signature to the Pre-Determined Frequency Signature: Identifying the Installed Frequency Signature as a Normal Frequency Signature of the Track System on the Vehicle

The method 1400 continues to step 1422 with in response to a comparison of the installed frequency signature to the pre-determined frequency signature of the track system, identifying the installed frequency signature as a normal frequency signature of the track system on the vehicle.

The pre-determined frequency signature of the track system may have been previously stored by the computer system 300. It is contemplated that in at least some embodiments of the present technology, the pre-determined frequency signature used during the step 1422 may be different from the pre-determined frequency signature used during the step 1408. For example, an other pre-stored frequency signature may be used during the step 1422 may be indicative of a desired frequency signature for the track system when installed on a given vehicle operating in the test conditions.

For example, the comparison may be indicative of a match between information about one or more peaks and/or information about one or more frequency intervals in the installed frequency signature and the corresponding ones in the pre-determined frequency signature. It is contemplated that information in at least a frequency portion of the installed frequency signature may be at least within a pre-determined threshold from information in at least a corresponding frequency portion the pre-determined frequency signature. It is contemplated that a match between the installed frequency signature and the pre-determined frequency signature, and/or the information of the installed frequency signature being within a pre-determined threshold from the information of the pre-determined frequency signature, the track system in the other configuration may be considered as being in an acceptable installed configuration for proceeding to an other step of the method 1400.

### Step 1424: In Response to a Comparison of the Installed Frequency Signature to the Pre-Determined Frequency Signature, Calibrating the Track System by Adjusting the Other Configuration to a Third Configuration

The method 1400 continues to step 1424 with in response to a comparison of the installed frequency signature to the pre-determined frequency signature of the track system, calibrating the track system by adjusting the other configuration to a third configuration.

The pre-determined frequency signature of the track system may have been previously stored by the computer system 300. It is contemplated that in at least some embodiments of the present technology, the pre-determined frequency signature used during the step 1424 may be different from the pre-determined frequency signature used during the step 1408. For example, an other pre-stored frequency signature may be used during the step 1422 may be indicative of a desired frequency signature for the track system when installed on a given vehicle operating in the test conditions.

For example, the comparison may be indicative of a mismatch between information about one or more peaks and/or information about one or more frequency intervals in the installed frequency signature and the corresponding ones in the pre-determined frequency signature. It is contemplated that information in at least a frequency portion of the installed frequency signature may be outside a pre-determined threshold from information in at least a corresponding frequency portion the pre-determined frequency signature. It is contemplated that a mismatch between the installed frequency signature and the pre-determined frequency signature, and/or the information of the installed frequency signature being within a pre-determined threshold from the information of the pre-determined frequency signature, the track system in the other configuration may be calibrated by adjusting the other configuration of the track system. Once adjusted, the track system is installed on the vehicle in the third configuration as opposed to in the other configuration.

Step 1426: Generating a Fourth Signal by the Sensor Device During Test Operation of the Vehicle with the Track System in the Third Configuration

The method 1400 continues to step 1426 with generating a fourth signal by the sensor device during test operation of the vehicle with the track system in the third configuration. For example, the vehicle with the track system may be operated in test conditions. During such vehicle-track test operation, the sensor device may be used to generate the fourth signal. For example, a third time-domain data signal may be generated by the pressure gauge 260 of the tensioner 250 of the track system 200 installed of the vehicle 402 while the vehicle 402 is operating in the test conditions.

### Step 1428: Generating an Other Installed Frequency Signature of The Track System in the Third Configuration on the Vehicle Based On the Fourth Signal

The method 1400 continues to step 1428 with generating an other installed frequency signature of the track system in the third configuration on the vehicle based on the fourth signal. It is contemplated that the fourth signal from the step 1426 may be the fourth time-domain signal, and the generating the other installed frequency signature includes generating a fourth frequency-domain signal based on the fourth time-domain signal. One or more spectral analysis techniques may be used for generating the other installed frequency signature. It should be noted that the other installed frequency signature may be indicative of operational parameters of one or more components of the track system in the third configuration installed on the vehicle.

### Step 1430: In Response to a Comparison of the Other Installed Frequency Signature to the Pre-Determined Frequency Signature: Identifying the Other Installed Frequency Signature as the Normal Frequency Signature of the Track System on the Vehicle

The method 1400 continues to step 1430 with in response to a comparison of the other installed frequency signature to the pre-determined frequency signature of the track system, identifying the other installed frequency signature as a normal frequency signature of the track system on the vehicle.

The pre-determined frequency signature of the track system may have been previously stored by the computer system 300. It is contemplated that in at least some embodiments of the present technology, the pre-determined frequency signature used during the step 1430 may be different from the pre-determined frequency signature used during the step 1408. For example, an other pre-stored frequency signature may be used during the step 1430 may be indicative of a desired frequency signature for the track system when installed on a given vehicle operating in the test conditions.

For example, the comparison may be indicative of a match between information about one or more peaks and/or information about one or more frequency intervals in the other installed frequency signature and the corresponding ones in the pre-determined frequency signature. It is contemplated that information in at least a frequency portion of the other installed frequency signature may be at least within a pre-determined threshold from information in at least a corresponding frequency portion the pre-determined frequency signature. It is contemplated that a match between the other installed frequency signature and the pre-determined frequency signature, and/or the information of the other installed frequency signature being within a pre-determined threshold from the information of the pre-determined frequency signature, the track system in the third configuration may be considered as being in an acceptable installed configuration.

1. A track system for a vehicle, the track system comprising:
a frame;
an idler wheel assembly rotatably connected to the frame;
an other component connected to frame;
an endless track extending around the frame, the idler wheel assembly, and the other component;
a tensioner operatively connecting to the frame with the idler wheel assembly for moving the idler wheel assembly with respect to the frame for tensioning the endless track;
a sensor device directly connected to the tensioner and not directly connected to the other component,
the sensor device being configured to capture a sensor signal indicative of an operational parameter of the tensioner, the sensor signal for indirectly determining an other operational parameter of the other component.

2. The track system of claim 1, wherein the other component is a support wheel assembly rotatably connected to the frame, and the other operational parameter being a frequency peak of the support wheel assembly during operation.

3. The track system of claim 2, wherein the support wheel assembly is a tandem support wheel assembly.

4. The track system of claim 1, wherein the other component is a sprocket wheel assembly rotatably connected to the frame, and the other operational parameter being a frequency peak of the sprocket wheel assembly during operation.

5. The track system of claim 1, wherein the idler wheel assembly is a first idler wheel assembly, and the other component is a second idler wheel assembly rotatably connected to the frame, and the other operational parameter being a frequency peak of the second idler wheel assembly.

6. The track system of claim 1, wherein the other component is the endless track, and the other operational parameter being at least one of a frequency peak of the endless track, a frequency peak of an outer thread of the endless track, a current misalignment of the endless track, a current debris ingestion, a current size of ingested debris, a current heat build-up in the endless track.

7. The track system of claim 1, wherein the sensor device is a pressure gauge directly connected to the tensioner, the operational parameter being a pressure measurement in the tensioner.

8. The track system of claim 1, wherein the sensor device is a positional sensor directly connected to the tensioner, the operational parameter being a stroke position measurement of the tensioner.

9. The track system of claim 1, wherein the sensor device is a first sensor device and the signal is a first signal, the track system further comprising:
a second sensor device directly connected to the tensioner and not directly connected to the other component, the second sensor device being configured to capture a second sensor signal indicative of a second operational parameter of the tensioner, the second sensor signal for determining the other operational parameter of the other component, the first sensor signal being different from the second sensor signal.

10. A track system for a vehicle, the track system comprising:
a frame;
a first component and a second component connected to the frame; and
a sensor device directly connected to the first component and not directly connected to the second component,
the sensor device being configured to capture a sensor signal indicative of a first operational parameter of the first component, the sensor signal for indirectly determining a second operational parameter of the second component.

11. The track system of claim 10, wherein the track system further comprises a wheel assembly pivotably connected to the frame, the first component being a tensioner operatively connected between the frame and the wheel assembly, the second component being an endless track extending around the frame and the wheel assembly, the tensioner for moving the wheel assembly with respect to the frame for tensioning the endless track.

12. A method of calibrating a track system, the method comprising:
assembling the track system in an initial configuration;
generating a signal by a sensor device of the track system during test operation of the track system in the initial configuration;
generating an initial frequency signature of the track system in the initial configuration based on the signal;
in response to a comparison of the initial frequency signature to a pre-determined frequency signature of the track system in a calibrated configuration, calibrating the track system by adjusting the initial configuration to an other configuration.

13. The method of claim 12, wherein the calibrating comprises replacing at least one of an idler wheel assembly, a frame, an endless track, and a tensioner of the track system.

14. The method of claim 12, wherein the calibrating comprises adjusting positioning of at least one of an idler wheel assembly, an endless track, and a tensioner of the track system relative to a frame of the track system.

15. The method of claim 12, wherein the signal is a time-domain signal, and the generating the initial frequency signature includes generating a frequency-domain signal based on the time-domain signal.

16. The method of claim 1, wherein the method further comprises:
generating an other signal by the sensor during test operation of the track system in the other configuration;
generating an other frequency signature of the track system in the other configuration based on the other signal;
comparing the other frequency signature to the pre-determined frequency signature.

17. The method of claim 1, wherein the method further comprises:
installing the track system in the other configuration on a vehicle;
generating a third signal by the sensor device during test operation of the vehicle with the track system in the other configuration;
generating an installed frequency signature of the track system in the other configuration on the vehicle based on the third signal.

18. The method of claim 17, wherein the method further comprises:
in response to a comparison of the installed frequency signature to the pre-determined frequency signature:
identifying the installed frequency signature as a normal frequency signature of the track system on the vehicle.

19. The method of claim 17, wherein the method further comprises:
in response to a comparison of the installed frequency signature to the pre-determined frequency signature, calibrating the track system by adjusting the other configuration to a third configuration;
generating a fourth signal by the sensor device during test operation of the vehicle with the track system in the third configuration;
generating an other installed frequency signature of the track system in the third configuration on the vehicle based on the fourth signal,
in response to a comparison of the other installed frequency signature to the pre-determined frequency signature:
identifying the other installed frequency signature as the normal frequency signature of the track system on the vehicle.

20.-21. (canceled)
